(19) United States
(12) Patent Application Publication
(10) Pub. No.: US 2026/0087453 A1
(43) Pub. Date: Mar. 26, 2026

(54) AUTOMATED CONTENT LABELER FOR COLLABORATION PLATFORMS

(71) Applicant: Atlassian Pty Ltd., Sydney (AU)

(72) Inventors: Tyler Brown, Bloomington, IN (US); Preethi Kandappan, San Jose, CA (US); Anand Srikrishnan Kashyap, Saratoga, CA (US)

(21) Appl. No.: 18/898,484

(22) Filed: Sep. 26, 2024

(51) Int. Cl. G06Q 10/101

(52) U.S. Cl. CPC G06Q 10/101

(57) ABSTRACT

Embodiments described herein relate to systems and methods for automated content labeling for collaboration platforms. A method includes receiving, at a graphical user interface (GUI), user input to create an automation rule, including a first input designating, for a label action, a label text for a label, and a second input designating, for the label action, a representative content for the label. The method generates the automation rule, including the label action, then, in response to a trigger criteria being satisfied for a page, extracting content from the page. The method includes generating, for a generative output engine, a first prompt comprising the extracted content and the representative content. A generative response may be received from the generative output engine, the response indicating the label, and associating the label with the page. A graphical indicator of the label and associated text may be displayed on the page.

### TECHNICAL FIELD

Embodiments described herein relate to multi-tenant services of collaborative work environments and, in particular, to systems and methods for automated content labeling for collaboration platforms.

### BACKGROUND

An organization can establish a collaborative work environment by self-hosting, or providing its employees with access to, a suite of discrete software platforms or services to facilitate cooperation and completion of work. In many cases, the organization may also define policies outlining best practices for interacting with, and organizing data within, each software platform of the suite of software platforms.

Often internal best practice policies require employees to thoroughly document completion of tasks, assignment of work, decision points, and so on. Such policies additionally often require employees to structure and format documentation in particular ways, to copy data or status information between multiple platforms at specific times, or to perform other rigidly defined, policy-driven, tasks. These requirements are both time and resource consuming for employees, reducing overall team and individual productivity.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system that includes a centralized automation rule service for the creation of automation rules.

FIG. 2 depicts an example frontend interface that supports automation rule creation and automated content labeling for collaboration platforms.

FIG. 3 depicts an example frontend interface that supports automation rule creation and automated content labeling for collaboration platforms.

FIG. 4 depicts an example frontend interface that supports automation rule creation and automated content labeling for collaboration platforms.

FIG. 5 depicts an example frontend interface that supports automation rule creation and automated content labeling for collaboration platforms.

FIG. 6 depicts an example frontend interface that supports automation rule creation and automated content labeling for collaboration platforms.

FIG. 7 depicts an example frontend interface that supports automation rule creation and automated content labeling for collaboration platforms.

FIG. 8 depicts an example frontend interface that supports automation rule creation and automated content labeling for collaboration platforms.

FIG. 9 depicts an example frontend interface that supports automation rule creation and automated content labeling for collaboration platforms.

FIGS. 10A-D depict example input fields of a component specification window for a label action component that supports automation rule creation and automated content labeling for collaboration platforms.

FIG. 11 depicts an example view of a graphical user interface in accordance with the embodiments described herein.

FIG. 12 depicts an example view of a graphical user interface displaying a list of a plurality of electronic documents or pages having the same label in accordance with the embodiments described herein.

FIG. 13 depicts an example view of a graphical user interface displaying labels in connection with issues of an issue tracking system.

FIG. 14 depicts an example method for collaboration content generation within a collaboration platform.

FIG. 15 depicts an example method for collaboration content generation within a collaboration platform.

FIG. 16 depicts a system diagram and network/communication architectures that may support a system as described herein.

FIG. 17 depicts a functional system diagram of network/communication architectures that may support a system as described herein.

FIG. 18 depicts a simplified system diagram and data processing pipeline.

FIG. 19 depicts a system providing multiplatform prompt management as a service.

FIG. 20 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems, devices, and methods for automatically generating rules for collaboration platforms, such as documentation systems, issue tracking systems, project management platforms, and the like.

Collaboration platforms can be used to generate, store, and organize user-generated content. As described herein, a collaboration platform or service may include an editor that is configured to receive user input and generate user-generated content that is saved as a content item. The terms “collaboration platform” or “collaboration service” may be used to refer to a documentation platform or service configured to manage electronic documents or pages created by the system users, an issue tracking platform or service that is configured to manage or track issues or tickets in accordance with an issue or ticket workflow, a source code management platform or service that is configured to manage source code and other aspects of a software product, a manufacturing resource planning platform or service configured to manage inventory, purchases, sales activity or other aspects of a company or enterprise. The examples provided herein are described with respect to an editor that is integrated with the collaboration platform. In some instances, the functionality described herein may be adapted to multiple platforms or adapted for cross-platform use through the use of a common or unitary editor service. For example, the functionality described in each example is provided with respect to a particular collaboration platform, but the same or similar functionality can be extended to other platforms by using the same editor service. Also, as described above a set of host services or platforms may be accessed through a common gateway or using a common authentication scheme, which may allow a user to transition between platforms and access platform-specific content without having to enter user credentials for each platform.

An automation rule (which may also be referred to as “automated rules,” or simply “rules”) is an automated workflow that is generally constructed in a “if this, then that” format. Typically, for example a collaboration platform, an automation rule results in the performance of an action upon the occurrence of a trigger, if certain conditions are met. In a collaboration platform, each automation rule is made by combining different types of components, including triggers and actions. An automation rule typically also includes a condition. Branches may also be used in some cases. As used herein, automation rules begin with a trigger (which may also be referred to as a trigger component, trigger criteria), the trigger being the catalyst that sets the execution of a rule in motion. In one or more embodiments, a condition (which may also be referred to as a condition component) may also be used, where the condition is a limit on the scope of the automation rule. For example, a condition may require that the rule may only be run when the action that initiated the trigger was performed by a certain user or group of users. As used herein, an action (or action component) is what the rule does or performs, for example what happens when the trigger (and conditions if applicable) is met. In some embodiments, an automation rule may also include a branch. A branch expands the performance or execution of a rule by adding a secondary path (a branch). As used herein, a branch is a sequence of conditions and/or actions that run in isolation from the rest of the rule, but are applied to each (e.g., every) instance of an object. For example, the rule for each task (e.g., an object) can be branched so that a message is sent to a recipient every time a person is mentioned on a particular page (e.g., when such page is published). This branch action occurs in addition to any action on the primary path of the automation rule chain.

In some cases, a collaboration platform may include a large amount of content to be managed. Certain tasks may require many repetitive actions or a person responsible for managing content may not realize that an action needs to be performed to manage the content. As such, a collaboration platform may benefit from allowing users to establish automation rules to automatically perform such tasks that would otherwise need to be performed manually. Such automation rules can reduce management overhead, saving time and freeing up resources, and add management consistency, increasing transparency and organization, while reducing errors.

A collaboration system including a large amount of content to be managed may benefit from the use of labels associated with content. Labels may also be said to be attached to, affixed to, tagged with, or otherwise corresponding to content. Labels are generally a versatile and flexible organizational tool that may be used in a collaboration platform, including across different collaboration platforms of a collaboration system. Labels can be used in a collaboration platform to categorize, tag, and group content in a flexible and user-friendly manner. Labels may act as metadata that can be attached to (e.g., associated with, etc.) to issues, pages, tasks, or cards, helping users to classify and retrieve content, including information from content, more efficiently. In some examples, unlike rigid categories or hierarchical structures, labels may provide a way to add context and meaning to content (e.g., content items) without imposing strict boundaries, making labels particularly useful in environments where projects are dynamic and evolving.

As an example, in an issue tracking platform (which may also be referred to as an issue tracking system), labels may be used to tag issues (e.g., an example of content in the issue tracking platform) with relevant keywords or topics. For example, a software development team might use labels to mark issues with specific features, components, or releases. This allows teams, which may include individual users or groups of users, to quickly filter and search for issues related to particular aspects of the project. Labels can also be used to signify priorities, responsibilities, or dependencies, helping teams to visualize and manage workflows more effectively. In some cases, by using labels strategically, teams can enhance their ability to track progress, identify blockers, and ensure that tasks and issues are not overlooked or forgotten.

As another example, in a document management platform (which may also be referred to as a document management system), labels may be used to tag pages, blogs, or spaces (e.g., an example of content in the document management platform) with relevant keywords or topics. The labels may allow users to group pages around common themes or topics, making it easier to navigate through large volumes of documents. For example, a company might use labels to categorize pages by department, project, or document type. As such, labels may enable users to quickly find related content, even if the content is spread across different spaces or sections of the document management platform. Labels in a document management platform can also be used to create dynamic content lists, such as automatically generating a list of all pages with a particular label, further enhancing the discoverability of information.

As yet another example, in a task tracking platform (which may also be referred to as a task tracking system), labels may be used to color-code and categorize cards on a board. These labels can represent different statuses, priorities, or categories, providing a visual way to organize and track tasks. Users can customize labels to fit their specific needs, such as designating tasks as high-priority, in progress, or requiring review. The color-coded nature of labels in a tasking tracking platform also makes it easy to get an at-a-glance overview of the state of a project, enabling teams to quickly assess what needs attention and where resources should be focused.

In some examples, labels may provide both flexibility and adaptability. Labels may be generally user-defined, such that they can be created, modified, or deleted as needed to fit the changing demands of a project or organization. As such, labels may be an ideal tool for teams that need to organize information in a way that evolves over time. Labels can be used in various ways depending on the specific context, such as tracking issues in an issue tracking platform, organizing documentation in a documentation platform, or managing tasks in a tasking tracking platform. Labels may thus provide structure without rigidity, making them a powerful feature for enhancing collaboration, improving productivity, and ensuring that information is both accessible and meaningful within a specific collaboration platform, as well as across different collaboration platforms of a collaboration system (e.g., in a multiplatform collaboration system).

Despite the significant power of labels, it may be time-consuming or otherwise resource intensive for users to create such labels (e.g., if no desired label currently exists), or otherwise attach such labels to content (e.g., for labels that exist but are not attached to particular content) of a collaboration platform. As such, automation rules may be defined to automatically create and/or attach labels to content. In some cases, it may be desirable for one or more labels to be attached to content upon the existence of a trigger criteria, as further explained below. Such automated label attachment may help streamline workflows and case the burden of label creation and attachment, as well as increase consistency of label application. That is, where an automation rule is used, labels may be applied in a more consistent manner to certain content. Consistent label application may aid users in locating content, including the most relevant content, without having to search across multiple labels for the same or similar types or categories of content.

In addition to the burden of attaching labels, users may need to decide which labels to attach to content. However, in some cases, a user may not know about different labels that exist for a collaboration platform. Moreover, a user may not know how particular labels should be used or are used in a collaboration platform. For example, a user may be unaware of a label policy that an organization has established for attaching a label to content. In some cases, a label name may also be ambiguous or otherwise have different meanings to different users, teams, or across different platforms. In addition, multiple different rules may arguably be applied to certain content, but a limited set of labels (e.g., one or two) may be desirable in some cases. A user may desire to apply only the one or two best labels. In some cases, “best” may refer to most relevant to other similar content of that user, team, or space, or within that particular collaboration platform. It may be challenging for a user to select the best label(s), especially where a large number of labels already exist. As such, and as further described herein, a generative output engine may be used by a label attachment automation rule to determine labels to attach to content in response to a trigger.

Automation rule creation (building) and automated content labeling for collaboration systems (e.g., using the automation rule) is further described herein. In one or more embodiments, an automation rule may use a generative output engine (e.g., which may use or be referred to as Atlassian intelligence (AI) in some cases) to select applicable labels and determine whether a label is to be attached.

In one or more embodiments, a user of a collaboration system, or a platform thereof (e.g., a user of one or more systems, programs, applications, or components of a collaboration platform), can generate an automation rule in an automation rule builder. The automation rule builder presents a graphical user interface (GUI) of the collaboration system (e.g., of one of the platforms of the collaboration system) to a user. The GUI may include an input field to receive user input to create an automation rule. Automation rule components, including triggers, conditions, and actions, have corresponding graphical elements that are generated for the GUI, and displayed for a user. The user may select a trigger criteria, including a corresponding trigger component, for the automation rule. The trigger criteria may be with respect to an object hosted by the collaboration platform. The object may represent content of a collaboration platform, such as a document of a documentation platform, an issue of an issue tracking platform, and so on.

In response to the selection of the trigger component, a graphical element representing the trigger criteria may be displayed, and the user may be presented with a number of automation rule components that may be added to the automation rule, including a label action (which may also be referred to as a labeler, label component, smart labeler, and so on). A user may select and/or input label text for the label associated with the label action. The user may also select and/or input representative content associated with the label action. In some examples, the representative content may be inserted by a user and, later, used by a generative output engine to determine what kind of content is associated with the label action. In other examples, the representative content may be generated by a generative output engine, for example based on other content of the collaboration platform, or data about content of the collaboration platform and/or the label. Using the label text and the representative content, an automation rule that includes the label action may be generated. In some examples, the label action and/or multiple label actions may be part of the automation rule. In some examples, one or more further actions, conditions, branches, or other automation components may also be part of the automation rule.

After (following, subsequent to) generating the automation rule, the trigger criteria may be satisfied for the content (e.g., a page, issue, and so on) of the collaboration platform. In response, content may be extracted (e.g., from the page, issue, and so on) and used to generate a prompt for the generative output engine. The prompt may further include the representative content as indicated by the automation rule. The generative output engine may return, in response to the prompt, a response indicating the label, which is then associated with the content. In some examples, the content may then be displayed with a graphical indicator of the label text for the label.

The described label actions and associated automation rule can more quickly and accurately determine labels for content, and better resolve ambiguity where a label may have more than one meaning. Automation rules using such label actions as further described herein can therefore save time, lower expenses, reduce errors, increase engagement with collaboration systems, and otherwise perform administrative and management tasks more effectively and efficiently.

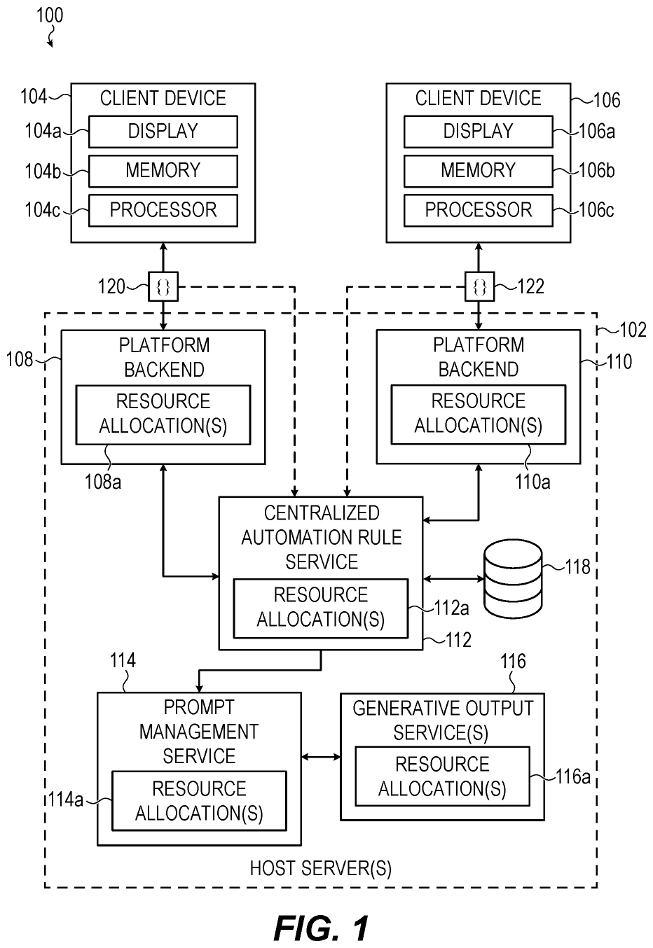

FIG. 1 depicts a simplified diagram of a system that includes a centralized automation rule service for the creation of automation rules, as described herein. The system 100 is depicted as implemented in a client-server architecture, but it may be appreciated that this is merely one example and that other communications architectures are possible.

In particular, the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices. Two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples are information technology system management (ITSM) systems, chat platforms, messaging platforms, and the like. These backends can be communicably coupled to a centralized automation rule service that can be leveraged to provide functionality to each respective backend. For example, the centralized automation rule service can be configured to receive user prompts, such as described herein, to modify, create, or otherwise perform operations to build, validate, debug, or otherwise create and manage automation rules acting on content stored by each respective software platform and triggered by events that may occur at one or more of the software platforms. The centralized automation rule service may provide a single, unified interface to automation rules that operate across different platforms of the host servers 102, providing management and creation capabilities across different platforms of the system.

By centralizing the automation rule service in this manner, the centralized automation rule service can also serve as an integration between multiple platforms. For example, one platform may be a documentation platform and the other platform may be an issue tracking system. In these examples, a user of the documentation platform may create an automation rule that is triggered off of an event that occurs at the documentation platform. An action in response to this event may be performed on one or more objects of the issue tracking system.

A portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each be communicably coupled with a centralized automation rule service 112 (also referred to as an “automation rule builder” or an “automation rule manager”).

The centralized automation rule service 112 can be configured to cause rendering of a GUI within respective frontends of each of the first platform backend 108 and the second platform backend 110. In this manner, and as a result of this construction, each of the first platform and the second platform present a consistent automation rule creation and management experience for a user.

The centralized automation rule service 112 may include both text input functions as well as selectable graphical elements to select and edit automation rules and components. Selected graphical elements may represent triggers and/or action across different platforms. As a result of the text input or selection of graphical elements, the centralized automation rule service 112 may present graphical elements representing the selected components that make up an automation, for example on the display 104a of a client device 104, or on the display 106a of the client device 106. As a result of this centralized architecture, multiple platforms in a multiplatform environment can leverage the features of the automation rule service. This provides a consistent experience to users while providing cross-platform features for the automation rules.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized automation rule service 112 that can be called by each respective frontend whenever it is required to present the user of that respective frontend with an interface to create and manage automation rules.

As described herein, a “content editing frame” references a user interface element that can be leveraged by a user to draft and/or modify rich content including, but not limited to formatted text; image editing; data tabling and charting; file viewing; and so on. These examples are not exhaustive; the content editing elements can include and/or may be implemented to include many features, which may vary from embodiment to embodiment. For simplicity of description, the embodiments that follow reference to a centralized automation rule service 112 are configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized automation rule service 112 can be extended to include additional features and functionality that, in turn, can automatically be leveraged by any further platform that incorporates an automation rule builder, and/or otherwise integrates with the centralized automation rule service 112 itself.

In some examples, prompts can be provided as input to a prompt engineering/prompt preconditioning service (such as the prompt management service 114) that, in turn, provides a modified user prompt as input to a generative output service 116. The generative output service 117 may be hosted over the host servers 102 or, in other cases, may be a software instance instantiated over separate hardware. In some cases, the generative output service 116 may be a third-party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on. In some cases, the generative output service 116 can be configured to provide an output as part of an action of an automation rule. The output can be in response to a prompt that includes content referenced by the automation rule, for example a summary of the content created when the automation rule is triggered and run.

Alternatively, when interacting with the same documentation system, a user having a role of “human resources professional” may be presented with prompts associated with manipulating or summarizing information presented in a directory system or a benefits system, instead of the issue tracking system or the code repository system.

More generally, in some embodiments described herein, a centralized automation rule service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized automation rule service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a GUI so as to present information to a user of the client device 104 and so as to collect information from a user of the client device 104. Collectively, the processor 104c, memory 104b, and display 104a of the client device 104 are identified as the resources of the client devices, respectively.

As with many embodiments described herein, the first platform frontend can be configured to communicate with the first platform backend 108 and/or the centralized automation rule service 112. Information can be transacted by and between the frontend, the first platform backend 108 and the centralized automation rule service 112 in any suitable manner, form, or format. In many embodiments, as noted above, the client device 104 and in particular the first platform frontend can be configured to send an authentication token 120 along with each request transmitted to any of the first platform backend 108, the centralized automation rule service 112, the preconditioning service, or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a GUI so as to present information to a user of the client device 106 and to collect information from a user of the client device 106. Collectively, the processor 106c, memory 106b, and display 106a of the client device 106 are identified as the client device resources, respectively.

As with many embodiments described herein, the second platform frontend can be configured to communicate with the second platform backend 110 and/or the centralized automation rule service 112. Information can be transacted by and between the frontend, the second platform backend 110 and the centralized automation rule service 112 in any suitable manner, form, or format. In many embodiments, as noted above, the client device 106 and in particular the second platform frontend can be configured to send an authentication token 122 along with each request transmitted to any of the second platform backend 110 or the centralized automation rule service 112.

As a result of these constructions, the centralized automation rule service 112 can provide uniform feature sets to users of either the client device 104 or the client device 106. For example, the centralized automation rule service 112 can implement an automation rule processor to receive an automation rule input provided by a user of the client device 104 to the first platform and/or to receive an automation rule input provided by a different user of the client device 106 to the second platform. Created automation rules may then be accessible to each user via the different ones of client device 104 and client device 106 for management, editing, and so on.

As noted above, the centralized automation rule service 112 ensures that common features are available to frontends of different platforms. One such class of features provided by the centralized automation rule service 112 invokes output of a generative output engine of a service such as the generative output service 116. For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system (not depicted with reference to system 100). For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

The prompt management service 114 can be configured to receive user input (provided via a GUI of the client device 104 or the client device 106) from the centralized automation rule service 112. The prompt management service 114 can also be configured to receive an automation rule input from the centralized automation rule service 112 in connection with running of an automation rule. The user input or automation rule input may include a prompt to be continued by the generative output service 116. The prompt management service 114 can be configured to modify the user input or automation rule input, supplement the input, select a prompt from a database (e.g., the database 118) based on the input, insert the input into a template prompt, replace words within the input, perform searches of databases (such as user graphs, team graphs, and so on) of either the first platform backend 108 or the second platform backend 110, change grammar or spelling of the input, change a language of the input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized automation rule service 112 to return to a suitable backend application, to in turn return to or perform a task for the benefit of a client device such as the client device 104 or the client device 106. More particularly, it may be appreciated that although system 100 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized automation rule service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, some embodiments described herein, and with particular reference to system 100, relate to systems for running automation rules. Those automation rules may collect one or more portions of content of the system 100, modify that user input into a particular engineered prompt, and submit that prompt as input to a trained large language model. Output of the LLM can be used in a number of suitable ways.

These foregoing embodiments depicted with reference to system 100 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized automation rule service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to KanbanBoard456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to KanbanBoard456, and whether the requesting user has read access to the referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized automation rule service.

As further described herein, the system 100 supports automation rule creation. In one or more embodiments, a GUI is displayed at a client device that includes an input field. In some cases, the client device 104, associated with the first platform backend 108, provides an interface with a first type of software platform, and the client device 106, associated with the second platform backend 110, provides an interface with a different type of software platform. Either or both of client device 104 or client device 106 may generate a GUI allowing user input for automation rule generation. As further described herein, the host servers 102 can utilize the services of a generative output service 116 to programmatically generate automation rules or portion of automation rules from inputs, including one or more natural language inputs or selections of graphical elements. In some examples, the generative output service 116 can be used to provide indications (e.g., suggestions, recommendations) for automation rule components for selection by a user as part of automation rule building and creation.

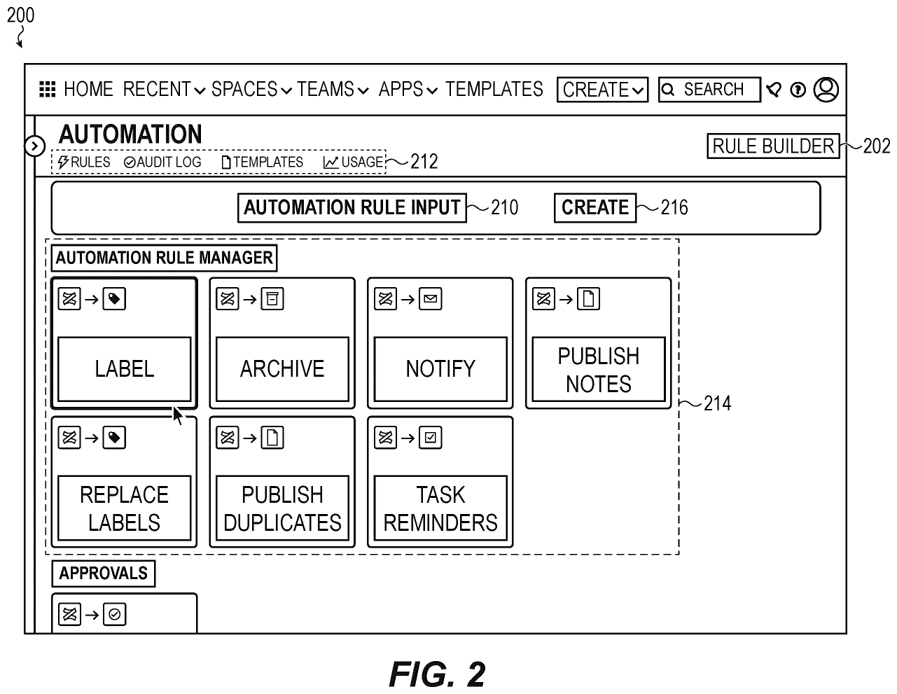

FIG. 2 depicts an example frontend interface 200 that supports automation rule creation and automated content labeling for collaboration platforms, in accordance with aspects described herein. Frontend interface 200 may also be referred to as a UI or GUI. The frontend interface 200 can be rendered by a client device 104 or a client device 106, which may be a personal electronic device such as a laptop, desktop computer, tablet, and the like. The client device can include a display with an active display area in which a user interface, e.g., frontend interface 200 can be rendered. The user interface can be rendered by operation of an instance of a frontend application associated with a backend application that collectively defines a software platform as described herein.

More particularly, as described with reference to system 100, a platform can be defined by communicably intercoupling one or more frontend instances with one or more backend instances. The backend instance of software can be instantiated over server hardware such as a processor, memory, storage, and network communications. The frontend application can be instantiated over physical hardware of a client device in network communication with the backend application instance. The frontend application can be a native application, a browser application, or other application type instantiated over hardware directly or indirectly, such as within an operating system environment.

As shown, frontend interface 200 includes rule builder button 202, a text input field 210, selectable tabs 212, a display area 214, and a create button 216. Text input field 210 is a field configured to accept textual inputs, for example a natural language rule for the creation of automation rules. The create button 216 can be used to submit the textual input in the text input field 210 for creation of an automation rule by the system 100, for example using or aided by a generative output service.

In one or more embodiments, selectable tabs 212 include tabs for “rules,” “an audit log,” “templates,” and “usage,” each of which may cause a different display to appear in display area 214. Selecting the rules field causes the display area 214 to display automation rules for management. The information for the displayed rule can include at least a name, description scope (e.g., on what projects, or types of projects, the rule will run), an indication of whether to allow the rule to run from another rule, an error notification status, an owner of the rule, a rule actor (e.g., the party indicated as responsible when the rule is executed), and permissions for the rule (e.g., persons or groups allowed to modify the rule). As an example of automation rules, an automation rule manager may display a list, icon, or other indicator of automation rules created by a user in display area 214. Examples of such automation rules (e.g., created or for a template, as further discussed herein) include a “label” rule (e.g., adding a specific label when a page is published by a certain author), an “archive” rule (e.g., archiving inactive pages when scheduled (recurring)), a “notify” rule (e.g., notify certain people about inactive pages when scheduled (recurring)), a “publish notes” rule (e.g., publish new meeting notes page when scheduled (recurring)), a “replace labels” rule (e.g., replace a label on all pages when scheduled (recurring)), a “publish duplicates” rule (e.g., publish the same set of pages when a new space is created), and a “task reminders” rule (e.g., remind teammates about incomplete tasks when scheduled (recurring)). In some embodiments, these example rules may support automation rules within a documentation platform. In other embodiments such rules, or other rules, can be for other platforms or a combination of platforms within a system including collaboration platforms.

In one or more embodiments, selecting the templates tab may cause a display to appear in display area 214 that includes templates that a user may utilize to create automation rules from a template. Such templates provide predefined structure for common automation rules that a user may want to use in the manual creation of an automation rule.

In one or more embodiments, selecting the audit log tab may cause a display to appear in display area 214 that includes an audit log for the automation rules. In one or more embodiments, each automation rule may include an audit log that identifies when the automation rule was triggered, the final result of the execution of the automation rule, and any action performed as a result of the automation rule execution. In some embodiments, the audit log may indicate a duration of the execution and the status (e.g., success, error, and so on) of the execution.

In one or more embodiments, selecting the usage tab may cause a display to appear in display area 214 that includes usage information for the automation rules. The usage information includes an outline of your automation usage (e.g., for a particular time frame). For example, each automation rule may be identified, together with a quantity of runs/executions of the automation rule, an “owner” or other responsible person for the rule, a scope of the rule (e.g., which collaboration systems are associated with the rule), and an activation status for the automation rule (e.g., whether execution of the rule is turned “on” or “off”).

According to one or more embodiments, previously-created automation rules, including automation rules generated from using a generative output engine, as further described herein, can be stored at the system 100. In some examples, rules may be stored in a database 118 for retrieval and use by a component of the set of host servers 102, such as the centralized automation rule service 112, the first platform backend 108, or the second platform backend 110. In some examples, the rules may be stored in the resource allocation of a portion of the host servers 102, such as the resource allocation of the platform from which the automation rule is to be executed, for example resource allocations 108a of the first platform backend 108, or resource allocations 110a of the second platform backend 110.

In one or more embodiments, the rule builder button 202 may be selected by a user to direct the frontend interface 200 to a rule builder that can be leveraged by a user to generate automation rules from components with assistance from graphical elements, as further described herein.

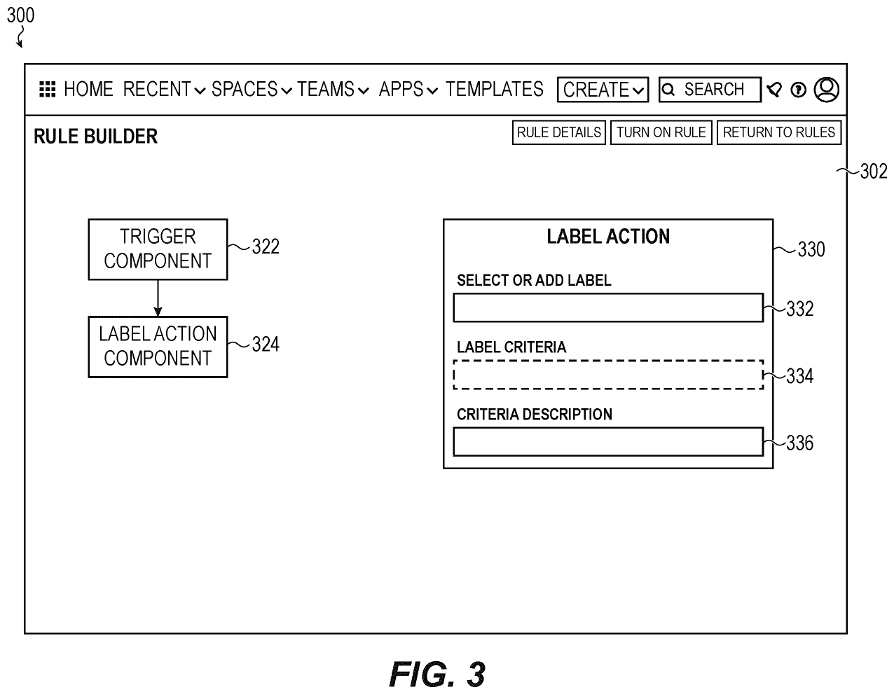

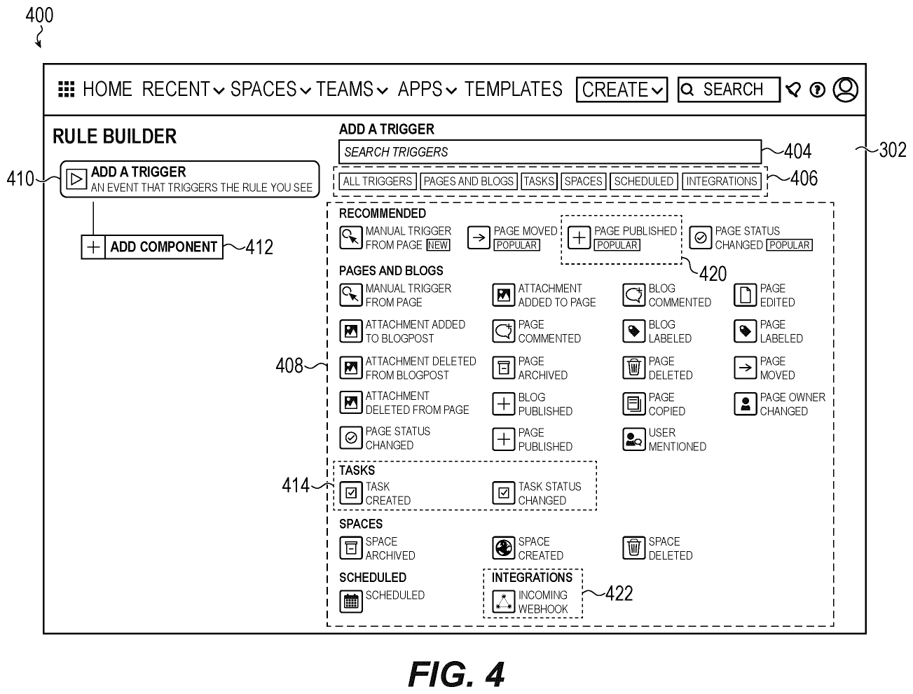

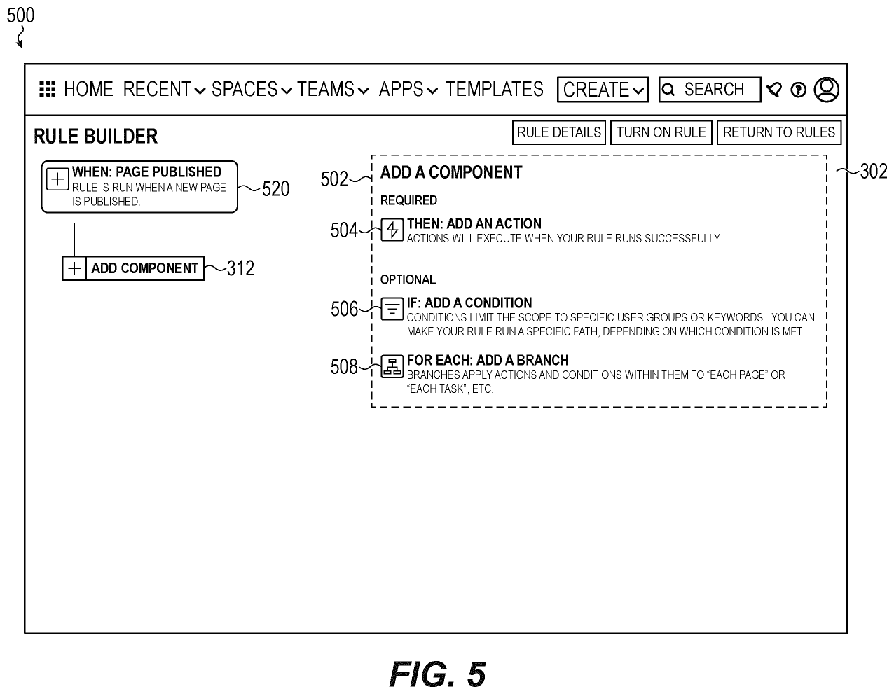

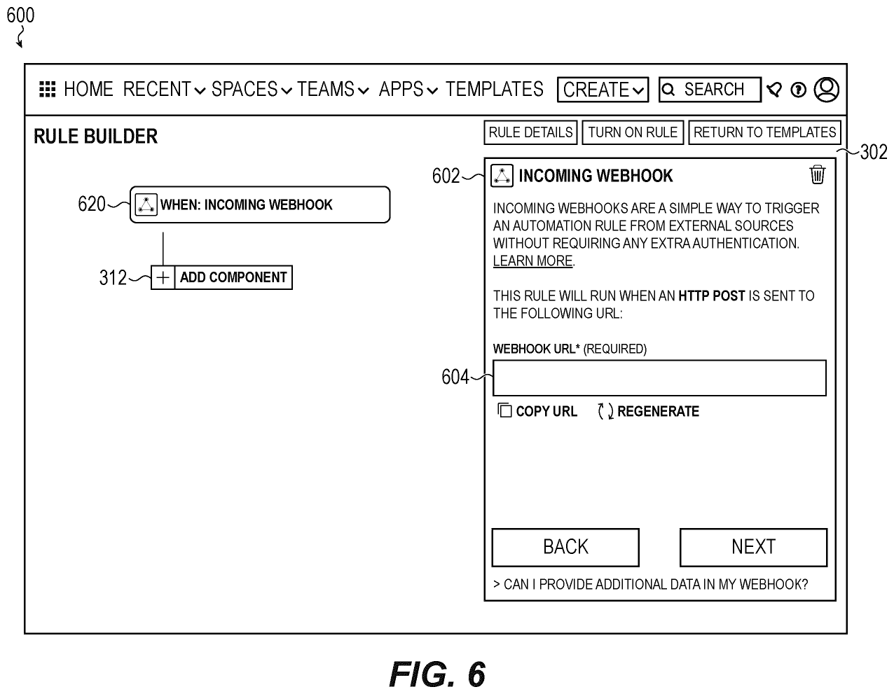

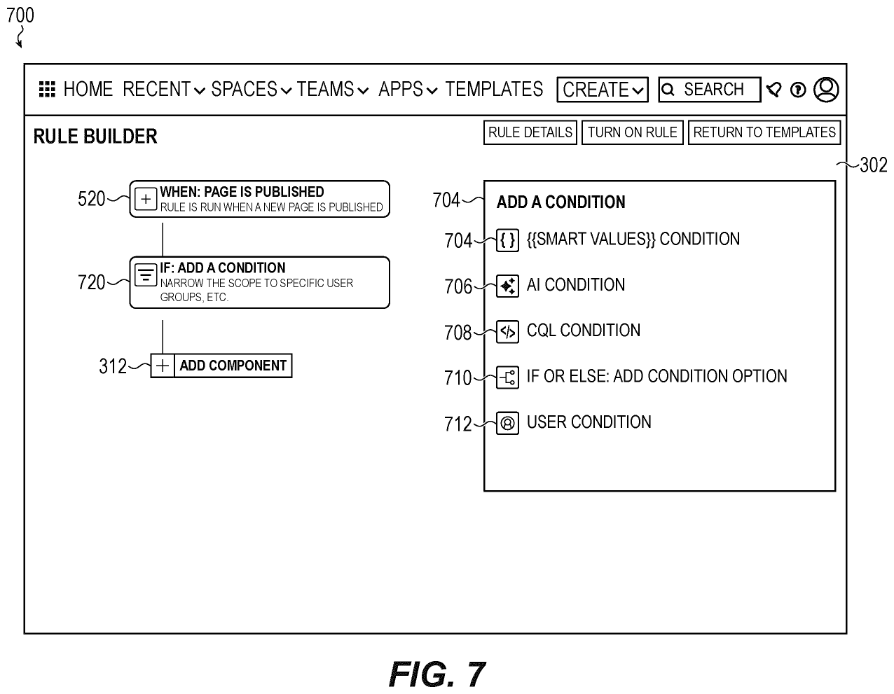

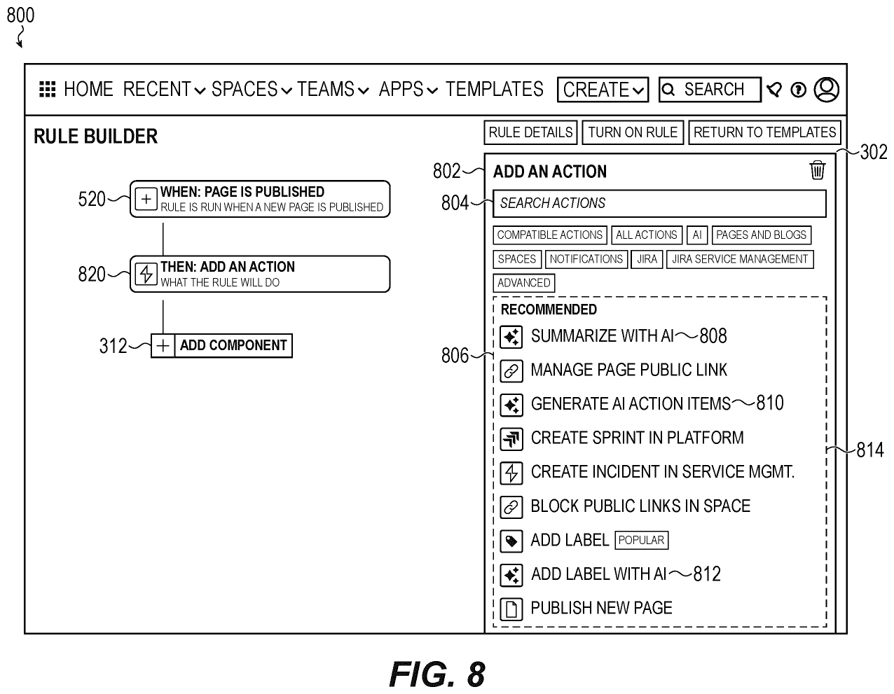

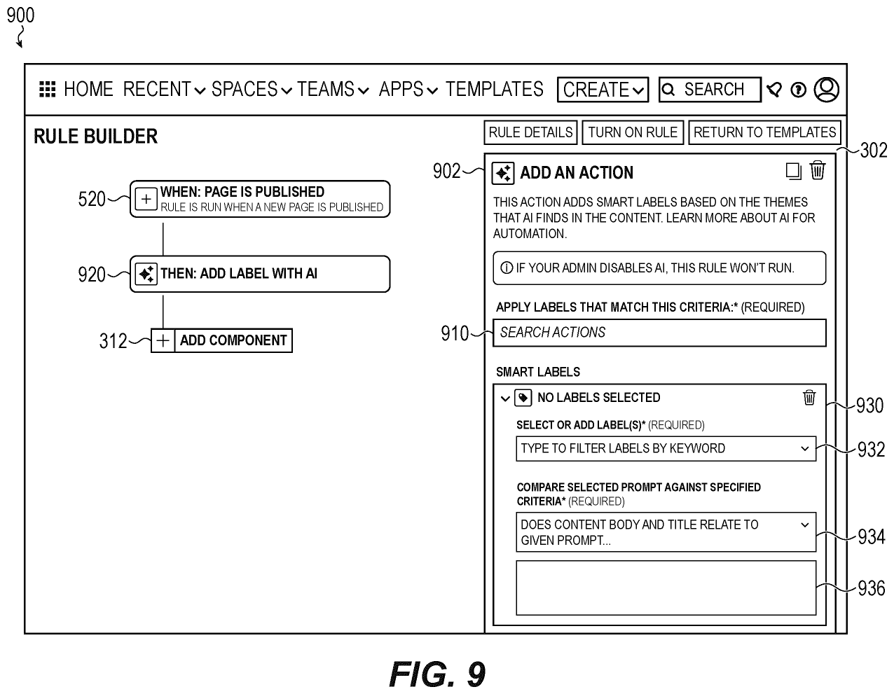

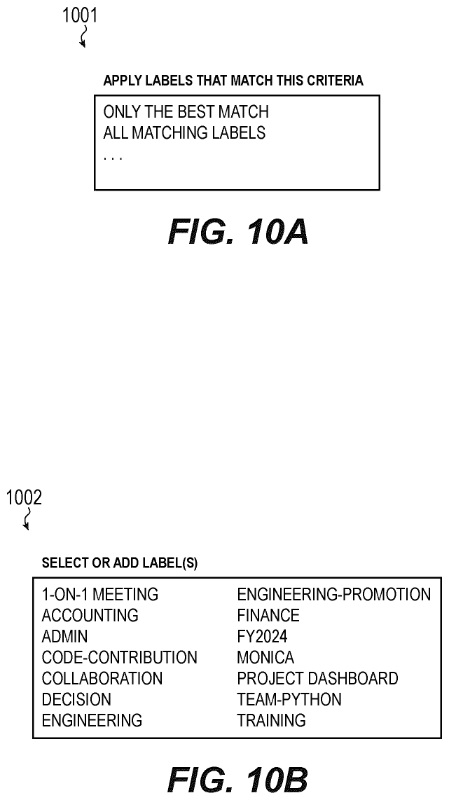

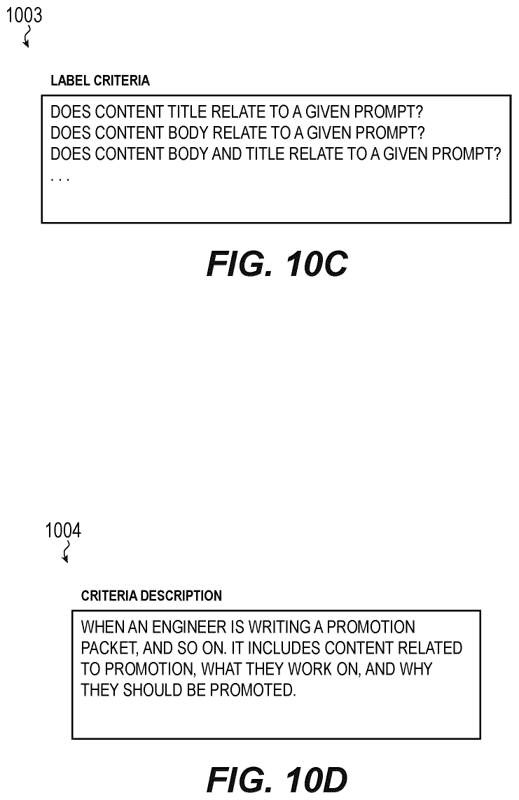

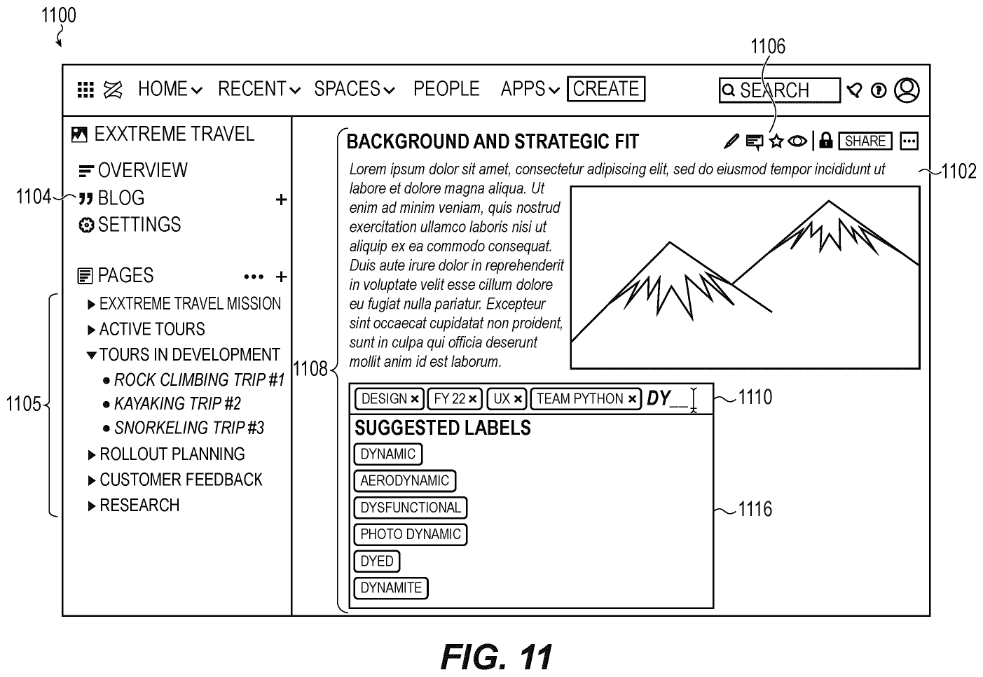

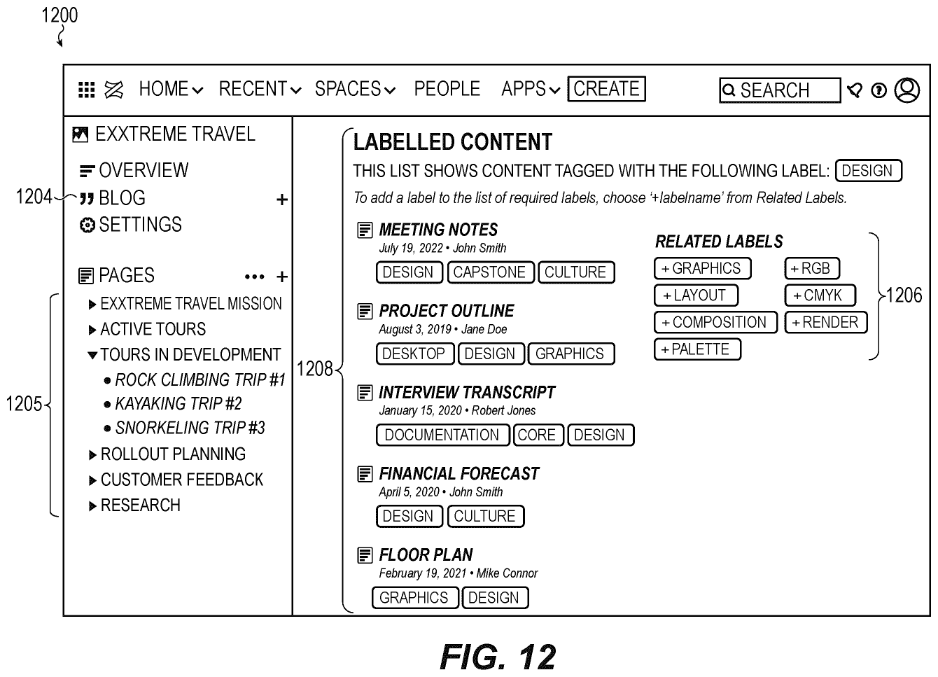

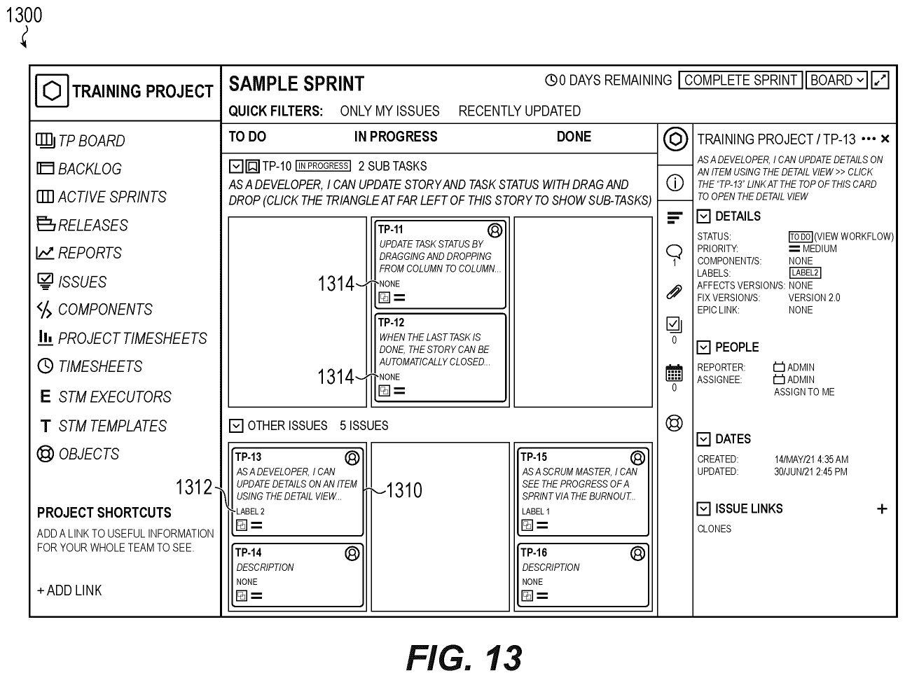

FIGS. 3-13 generally depict frontend interfaces in an example of a flow to generate an automation rule. FIG. 3 generally depicts an interface that is used to generate an automation rule that automatically labels content utilizing a generative output engine. FIG. 4 generally depicts an interface for the selection of a trigger component for an automation rule flow. FIG. 5 generally depicts required and optional component categories for a user to select to display additional automation rule components to add to the automation rule flow, incorporating the previously-selected trigger component. FIG. 6 generally depicts an example of the trigger component being an incoming webhook. FIG. 7 generally depicts the selection of a condition component for an automation rule flow, incorporating a previously-selected trigger component. FIG. 8 generally depicts the selection of an action component, including a label action component that utilizes a generative output engine. FIG. 9 generally depicts the selection of specifics of a label action component for an automation rule flow, the label action utilizing the generative output engine. FIGS. 10A-10D generally depict the further selection of specifics for the label action component that utilizes the generative output engine. FIG. 11 generally depicts a first example view of a graphical user interface showing labels associated with content of a document management platform. FIG. 12 generally depicts a second example view of a graphical user interface showing labels associated with content of the document management platform. FIG. 13 generally depicts an example view of a graphical user interface showing labels associated with content of an issue tracking platform.

FIG. 3 depicts an example frontend interface 300 that supports automation rule creation and automated content labeling for collaboration platforms, in accordance with aspects described herein. Frontend interface 300 may also be referred to as a UI or GUI. In one or more embodiments, frontend interface 300 may be displayed at a same display or interface as frontend interface 200, for example rendered in response to a user selecting the rule builder button 202. The frontend interface 300 displays the rule builder 302, which includes graphical elements to assist a user in generating an automation rule to operate in a collaboration system (e.g., system 100), as further described herein. In some embodiments, rule builder 302 may be at least a part of a GUI that is rendered by one of first platform backend 108 or second platform backend 110.

In one or more embodiments, rule builder 302 may include a proposed automation flow (or workflow) region 304 and a control region 306.

Generally, the proposed automation flow region 304 includes graphical elements representing automation rule components. In some examples, the graphical elements representing automation rule components may be replaced during rule building with graphical elements representing selected automation rule components. For example, the proposed automation flow region 304 may include a trigger adding button (e.g., trigger adding button 410 further discussed with reference to FIG. 4) that may be replaced by a graphical element representing a trigger component 322 that is selected. The trigger adding button 410 may also generally be a component adding button. The trigger component may be used to designate a trigger criteria with respect to an object hosted by the collaboration platform, the object including content of the collaboration platform.

The proposed automation flow region 304 may further include a label action adding button for a label action component 324, which may also generally be a component adding button. The proposed automation flow region 304 may further include one or more additional components, which may include a condition component, branch component, or additional action components.

As shown in the frontend interface 300, the label action component 324 may be modified via a label action window 330 used to set, modify, or otherwise define characteristics of the label action component 324. Generally, the label action window 330 may be used to select or add one or more labels for the label action component 324 via a first input 332, and via a second input 334 (a label criteria field) and define representative content and a content source to be used to evaluate whether a label should attach to the content via a third input 336 (a criteria description field), respectively.

The first input 332 may be used to provide label text for a label. In some examples, the label may be selected via a drop-down menu that provides a list from which a label may be selected (e.g., as further described herein with reference to FIG. 10B). Label text may also be provided by a user by entering a text string in the first input 332, where such label may be new (e.g., not already in the collaboration platform) or existing. In some examples, the first input 332 may provide a search function to a database of labels associated with a particular collaboration platform. In yet other examples, a user may enter a text string in the first input 332, and the collaboration platform may provide one or more suggested labels based on the entered text string.

The second input 334 may be used to select or provide a label criteria for the label action. For example, the second input 334 of the graphical user interface may be used to designate one or more portions of content of the collaboration platform (e.g., a page in a document management system, an issue in an issue tracking system, and so on) as a source of the extracted content. In some examples, the one or more portions of the page comprise a body of the page, a title of the page, or a combination of the body and the title.

The third input 336 may be used to select or provide representative content for the label of the label action. In some examples, string text may be provided by the user in the third input 336. The string text may be a user's description of the label, what the label is used for, other items to which the label may be applied, what the label should not be applied to, and/or any other user generated and provided textual description of the label for the label action. In other examples, a generative output engine may provide, or be used to generate, the representative content of the third input 336. For example, the third input 336 may be used to specify one or more parameters used to generate a prompt provided to the generative output engine to generate the representative text. In some cases, the collaboration system (e.g., system 100) may be preconfigured to select a source for the representative text, such that a prompt provided to the generative output engine includes such source. In either case, the collaboration system may extract content (e.g., text) from other content having the same label as the label action, a subset of content, content sharing the same label, and so on. The subset of content may be a most viewed or most popular set of content, content associated with the same user or group of users, content in the same space, content in the same collaboration platform, and so on.

As used herein, an input or input field may generally be populated via a text entry, or be populated via a dropdown selection. In some cases, text may be suggested (e.g., auto-populated) as a user types. The suggestion may be context-specific. For example, the suggested text may be different for label criteria than for the criteria description. Similarly, the suggested text may be component-type specific, for example different for a label action component in a document management platform than a label action component in an issue tracking platform.

Although described with reference to a single label, the label action component 324 may include multiple labels. In some examples, the multiple labels may have the same label criteria and/or criteria description apply to the multiple labels for the label action component 324. Additionally, or alternatively, the multiple labels may have different label criteria and/or criteria description apply to them for the label action component 324.

In one or more embodiments, the object that triggered the trigger component 322 may have different content than the content that is to be labeled according to the automation rule. For example, the automation rule may act across different pieces of content, where a first object including first content triggers (e.g., via trigger component 322) the automation rule that includes the label action component 324, and the label action component 324 labels a second content of a second object.

In one or more embodiments, the object that triggered the trigger component 322 may be of a first platform (e.g., the first platform backend 108), and the object referenced by the label action component 324 may be of a second platform (e.g., the second platform backend 110). That is, the object to be labeled by the label action component 324 may be of a different platform than the object that triggered the automation rule via the trigger component 322. For example, a trigger may be satisfied by a change of status of a ticket in an issue tracking system, and a document within a documentation platform may be labeled in response. In another example, a non-platform object may trigger the automation rule, and the object of the label action component 324 may be of one of the platforms (e.g., the first platform backend 108 or the second platform backend 110). Alternatively, in other embodiments, the object that triggered the automation rule may be of one of the platforms, while the object of the label action component may be a non-platform object.

In some embodiments, user permissions may be evaluated when the automation rule is run, including when the automation rule operates across platforms, or between one of the platforms and a non-platform system. That is, as part of running an automation rule that starts, is initiated, or otherwise triggered in a first platform, one or more conditions or actions (including a label action) may use a second platform as described herein. In such cases, the process of performing the automation may further include verifying or checking the credentials (permissions) of a user with the second platform. In other embodiments, access may be granted or denied based on a user role. Where an automation rule has been created (e.g., established as a service), if the user does not have sufficient permissions to access an object of the second platform, then the automation rule may cease to run or fail. In one or more embodiments, an error message or other indicator may be provided to the user or logged to indicate the failure to run the automation rule by reason of a lack of permissions. In some embodiments, where one or more components of the automation rule require checking permissions to access an object of a platform (e.g., the second platform or a non-platform system referenced by the automation rule), a GUI may be displayed to a user for the user to enter the user's credentials associated with that platform. The entered credentials may then be provided to the platform to allow the automation rule to continue to run.

In one example, a label action (e.g., a label action using the generative output engine as further described herein), may be used to update both the content that triggered the automation rule with the label action and related content (e.g., a parent page in a hierarchy of pages) with the label and/or a corresponding or associated label. For example, if a user creates a page in a particular group of pages, a summary or other parent page may be created or updated with information from the newly created child page, and tagged according to the label action. For example, the parent page may include a summary and/or action items generated by the content generation engine. Upon creation of a new child page (e.g., in a designated group or set of pages), the content generation engine may be used to update the parent summary and/or the action items, including associating a label determined to apply to the child page. A prompt may be generated with instructions and/or a template, the old parent page, the new child page, and sample input-outputs, and a new parent page returned by the generative output engine. Alternatively, the prompt may be generated with instructions and/or a template, the old child paged, the new child page, and sample input-outputs, and a new parent page returned by the generative output engine that can replace the old parent page.

FIG. 4 depicts an example frontend interface 400 that supports automation rule creation and automated content labeling for collaboration platforms, in accordance with aspects described herein. Frontend interface 400 may also be referred to as a UI or GUI. In one or more embodiments, frontend interface 400 may be displayed at a same display or interface as frontend interface 200 or frontend interface 300, for example rendered in response to a user selecting the rule builder button 202. The frontend interface 400 displays the rule builder 302, which includes graphical elements to assist a user in generating an automation rule to operate in a collaboration system (e.g., system 100), as further described herein. In some embodiments, rule builder 302 may be at least a part of a GUI that is rendered by one of first platform backend 108 or second platform backend 110.

In one or more embodiments, rule builder 302 may include a proposed automation flow (or workflow) region 304 and a control region 306.

Generally, the proposed automation flow region 304 includes graphical elements representing automation rule components. In some examples, the graphical elements representing automation rule components may be replaced during rule building with graphical elements representing selected automation rule components. For example, the proposed automation flow region 304 may include a trigger adding button 410 that may be replaced by a graphical element representing a selected trigger component, and a component adding button 412 that may be replaced by a selected action component. The proposed automation flow region 304 may expand or contract as automation rule components (and their respective graphical elements) are added or deleted.

Generally, the control region 306 may include a search box for automation rule components, tabs for categories of those automation rule components, and graphical elements representing selectable automation rule components.

In one or more embodiments, the rule builder 302 of the frontend interface 400 may include a search box 404, a set of tabs 406, and a set of trigger components 408 in the control region 306, and a trigger adding button 410 and a component adding button 412 in the automation workflow region 304. Frontend interface 400 illustrates a simplified view. In some embodiments, rule builder 302 may be embedded within another GUI (e.g., window), or include one or more additional textual and/or graphical elements not shown with reference to frontend interface 400.

The search box 404, the set of tabs 406, and the set of trigger components 408 may be rendered and displayed to a user, for example responsive to the user initiating (starting, entering) the rule builder 302 and selecting the graphical element that is the trigger adding button 410. In some embodiments, after selecting a trigger component for an automation rule, a user may select the graphical element that is the add a component, button 412. In other embodiments, a user may select the graphical element that is the add a button 412 before selecting the trigger component.

The set of trigger components 408 includes trigger components that may be used to initiate an automation rule based on an event. In some embodiments, the triggers may be organized into one or more groups or subsets of triggers components. In the example of the frontend interface 400, the groups include recommended, pages and blogs, tasks, spaces, scheduled, and integrations. In this example, the recommended triggers include a manual trigger from a page, a page moved, a page published, or a page status changed, for example page published trigger 420. The pages and blogs triggers include a manual trigger from a page, at attachment added to a blogpost, an attachment added to a page, at attachment deleted from a blogpost, an attachment deleted from a page, a blog commented, a blog labeled, a blog published, a page archived, a page comments, a page copied, a page deleted, a page edited, a page labeled, a page moved, a page owner changed, a page published, a page status changed, or a user mentioned. The task triggers include task created and task status changed. The spaces triggers include space archived, space created, or space deleted. The scheduled triggers include a scheduled trigger. The integrations triggers include an incoming webhook trigger, for example incoming webhook trigger 422.

In one or more embodiments, the recommended triggers of the set of trigger components 408 may be based on a usage history for the user, such as the quantity of uses for the trigger component exceeding a threshold value or the user's most used trigger components (e.g., ten most used trigger components). In other embodiments, the recommended triggers are based on the quantity of uses by a group of users (e.g., of the platform, or accessing a centralized automation rule service 112), and may include the most used trigger components or the trigger components whose usage has exceeded a threshold value. In some cases, the recommended triggers may be a curated list within a platform or the centralized automation rule service 112, and may depend on which platform a user is accessing. In some embodiments, the generative output service 116 may be trained on the usage of trigger components for automation rules within a platform or set of platforms, and be used to determine the recommended trigger components based on one or more inputs and a list of potential or candidate trigger components. In some examples, the generative output service 116 can receive (e.g., from the centralized automation rule service 112) information regarding a history of trigger component selections (e.g., for a particular user, group of users, particular platform, or by other groupings), and this information used by the generative output service 116 to provide (e.g., from the centralized automation rule service 112) an indication (e.g., suggestion or recommendation) for a trigger component or set of trigger components 408 (e.g., as the “recommended” trigger components) as part of automation rule building and creation.

The trigger groups for the set of trigger components 408 may be selectable via the set of tabs 406. For example, by selecting the “tasks” selectable element, the set of trigger components 408 may be pared down to display only the associated task triggers 414 (e.g., task created and task status changed), and the other available trigger components hidden.

Search box 404 accepts textual inputs from a user, and in response, the rule builder 302 can filter the set of trigger components 408. In some embodiments, the displayed set of trigger components 408 may be pared down such that only trigger components that satisfy the search are displayed (and other, non-responsive trigger components hidden). In other embodiments, a drop-down or pop-up may be displayed that includes selectable trigger components that satisfy the search.

In some embodiments, trigger components may include one or more of a field value changed, form submitted, incoming webhook, issue assigned, issue commented, issue comment edited, issue created, issue deleted, issue linked, issue link deleted, issue moved, issue transitioned, issue updated, a manual trigger from an issue, a combination of issues, when work is logged, a sprint is created, started, or completed, a version is created, updated, or released, a branch created, build failed, build status changed, build successful, commit created, deployment failed, deployment status changed, deployment successful, pull request create, pull request, declined, pull request merged, vulnerability found, object triggered, service limit breach, a service legal agreement threshold breached, approval required, approval completed, or an emoji reaction to application message. In some embodiments, these example triggers are intended for use with reference to the context of an issue tracking platform.

Additionally, or alternatively, trigger components may include one or more of a page archived, page commented, page copied, page deleted, page edited, page labeled, page moved, page owner changed, page published, page status changed, attachment added to page, attachment deleted from page, attachment deleted from page, manual trigger from page, task created, task status changed, blog commented, blog labeled, blog published, attachment added to blog, attachment deleted from blog, user mentioned, space archived, space created, or a combination of these. In some embodiments, these example triggers are intended for use with reference to the context of a documentation platform.

FIG. 5 depicts an example frontend interface 500 that supports automation rule creation and automated content labeling for collaboration platforms, in accordance with aspects described herein. Frontend interface 500 may be an example of frontend interface 200, frontend interface 300, or frontend interface 400 following selection by a user of a page published trigger component, for example page published trigger 420. Following selection, the page published trigger 520 may be shown as part of the automation rule flow.

In one or more embodiments, rule builder 302 of the frontend interface 500 may include a component addition box 502 that indicates required and optional components for an automation rule. In particular, in addition to a trigger component, an automation rule requires at least one action component. Action components are automation rule components that will execute if the automation rule runs successfully (e.g., based on a detected triggering event). As such, a selectable graphical element for an action component 504 is displayed. Upon selection (e.g., via point click or double-click, or drag and drop to the add component graphical element, such as button 512), action components may be displayed in the rule builder 302 as further discussed herein.

An automation rule may use one or more additional components, such as conditions or branch components, including one or more condition components that utilize a generative output engine as further described herein. As such, component addition box 502 may also include selectable graphical elements for a condition component 506 and a branch component 508.

Condition components are automation rule components that limit the scope of the automation rule to specific user groups or keyworks. For example, a condition may limit a rule to run on a specific path, depending on which condition is met (satisfied). In one or more embodiments, there is a single event condition. In other embodiments, multiple event conditions are used, and may be set to occur at any point within the automation rule chain. In some embodiments, event condition(s) are in if-then or if-then-else form. In one or more embodiments, examples of event conditions include a user, a database query (e.g., a CQL query), such as a query in the form of an “if” statement for a content of a page, blog, comment, or attachment, a compare, an if-else statement, or a combination of these. In some embodiments, these conditions are for a documentation platform.

In one or more embodiments, examples of event condition(s) include compare functions, which may be values or regular expressions. In one or more embodiments, values for a compare function may include one or more of an issue, conditional logic, users, test fields, date and time, JavaScript Object Notation (JSON) function, math expression, list, or a combination of these. In some embodiments, these conditions are for an issue tracking platform.

Branch components are automation rule components that apply actions and conditions within each branch to each task, each page, and so on. In some embodiments, a branch component is similar to a “for each” requirement.

According to the example shown for frontend interface 500, the trigger component is a page published trigger 520. In other embodiments, other triggers, including other example trigger components described herein or any other suitable trigger component for an automation rule, may be used consistent with a condition component that uses a generative output engine, as further described herein.

FIG. 6 depicts another example frontend interface 600 that supports automation rule creation and automated content labeling for collaboration platforms, in accordance with aspects described herein. Frontend interface 600 may be an example of frontend interface 200, frontend interface 300, or frontend interface 400 following selection by a user of an incoming webhook trigger component, for example incoming webhook trigger 422. Following selection, the incoming webhook trigger 620 may be shown as part of the automation rule flow.

For the incoming webhook trigger 620, a component specification window 602 may be displayed, for example when a user selects to include the incoming webhook trigger 620 in the automation rule, or upon selection of the incoming webhook trigger 620 during modification or editing of the automation rule flow. The component specification window 602 includes an input field 604 for the input of a universal resource locator (URL) for the webhook. Webhooks are generally automated messages sent from applications when something happens at that application. The webhook may have a payload that is sent to the URL of the webhook, thus acting as a triggering event for the automation rule that uses an incoming webhook trigger 620.

FIG. 7 depicts an example frontend interface 700 that supports automation rule creation and automated content labeling for collaboration platforms, in accordance with aspects described herein. Frontend interface 700 may be an example of frontend interface 500 or frontend interface 600 following selection by a user of a generic condition component 720. Following selection, the generic condition component 720 may be shown as part of the automation rule flow, and a condition selection window 702 displayed adjacent the automation rule flow in the rule builder 302.

The condition selection window 702 presents condition components that are available to be added to the automation rule. In one or more embodiments, one or more condition components may include condition components that utilize a generative output engine. For example, the AI condition 706 may be selectable to provide a condition component using the generative output engine. Examples of other condition components include a smart values condition 704, a CQL condition 708, an if-or-else condition 710, and a user condition 712.

FIG. 8 depicts an example frontend interface 800 that supports automation rule creation and automated content labeling for collaboration platforms, in accordance with aspects described herein. Frontend interface 800 may be an example of frontend interface 500 or frontend interface 600 following selection by a user of a generic action component 820. Following selection, the generic action component 820 may be shown as part of the automation rule flow, and an action selection window 802 displayed adjacent the automation rule flow in the rule builder 302.

The action selection window 802 presents a set of action components 806 that are available to be added to the automation rule. A search input field 804 may be used to search for and identify action components from the set of action components 806. In one or more embodiments, one or more action components may include action components that utilize a generative output engine. For example, the summarize with AI action, action 808, may be selectable to provide an action component that utilizes the generative output engine to provide a summary of a content portion of an object. In another example, the generated AI action items, action 810, may be selectable to provide an action component that utilizes the generative output engine to generate a list of action items from a content portion of an object. Examples of other action components of the set of action components 806 include a manage page public link action, a create sprint in platform action, a create incident in service management action, a block public links in space action, an add label action, a change page status action, and a publish new page action.

Generally, each action component of the set of action components 806 indicates the action to be performed following the trigger component, page published trigger 520, and satisfaction of a condition component (not shown), if any. The action indicates the object on which the action is performed. Actions are what the automation rule is to do or, stated differently, what happens if the automation rule executes successfully.

In some embodiments, the set of action components 806 may be organized into one or more groups or subsets of action components. For example, the groups may include recommended pages and blogs, spaces, notifications, Jira (e.g., an example of issue tracking system), and advanced. For example, the recommended actions may include a transition an issue in Jira, edit an issue in Jira, add a label, add a label using a generative output engine (e.g., “add label with AI”), change page status, create issue in Jira, publish a new page, restrict a page, or send an email. The pages and blogs actions may include adding a comment, adding a label, archiving a page, change a page owner, change a page status, copy a page, delete a blog, delete a page, manage watchers, move a page, publish a new page, remove a label, or restrict a page. The spaces actions may include archiving a space, creating a space, or granting space permissions. The notification actions may include sending an email, sending a message through a first platform (e.g., a Microsoft Teams message), sending a message through a second platform (e.g., a Slack message), sending a message through a third platform (e.g., a Twilio notification), or send a web request. The Jira actions may include transitioning an issue, editing an issue, or creating an issue. The advance actions include creating a lookup table, creating a variable, or logging an action.

The action groups for the set of action components 806 may be selectable via a set of tabs. For example, by selecting the “spaces” selectable element, the set of action components 806 may be pared down to display only the associated spaces actions (e.g., archive space, create space, and grant space permission), and the other available action components hidden.

Search input field 804 (e.g., a search box) accepts textual inputs from a user, and in response, the rule builder 302 can filter the set of action components 806. In some embodiments, the displayed set of action components 806 may be pared down such that only action components that satisfy the search are displayed (and other, non-responsive action components are hidden). In other embodiments, a drop-down or pop-up may be displayed that includes selectable action components that satisfy the search.

In one or more embodiments, actions of the set of action components 806 include one or more of page archiving, page ownership changing, page status changing, page copying, page deletion, page moving, new page publishing, page restriction, blog deletion, comment addition, label addition, label removing, watcher management, space permission adding, space archiving, or a combination of these. In some embodiments, these actions are for a documentation platform.

In one or more embodiments, actions of the set of action components 806 include one or more of email sending, application message sending, text message sending, web request sending, variable creation, action logging, or a combination of these. In some embodiments, these actions are for an issue tracking platform.

As depicted, the recommended actions 814 include an action 808 to summarize with a generative output engine (“summarize with AI”), an action 810 to generate a list of action items using a generative output engine (“generate AI action items”), and an action 812 to add a label to content using a generative output engine (“add label with AI”).

FIG. 9 depicts an example frontend interface 900 that supports automation rule creation and automated content labeling for collaboration platforms, in accordance with aspects described herein. Frontend interface 900 may be an example of frontend interface 500, frontend interface 600, frontend interface 700, or frontend interface 800 following selection by a user of an action component that utilizes a generative output engine to generate a label for content of the collaboration system, and associate the label with the content. Following selection, the label action component 920 may be shown as part of the automation rule flow.

For the label action component 920, a component specification window 902 may be displayed, for example when a user selects to include the label action component 920 in the automation rule, or upon selection of the label action component 920 during modification or editing of the automation rule flow.

In one or more embodiments, the component specification window 902 may provide a criteria specification input 910 (e.g., “apply labels that match this criteria”). The criteria specification input 910 may allow a user to input, provide, select, or otherwise specify a selection criterion for the label action component 920, for example from a set of candidate selection criteria shown in a drop-down menu.

In some examples, the selection criteria includes a best label, for example as determined by a generative service. As used herein, the generative service includes one or more resources of a collaboration system (e.g., the collaboration system 100, system 1600, system 1700, system 1800, and/or system 1900) that may perform pre-processing of information (e.g., text, content) to be provided to a generative output engine, prompt creation for the generative output engine, and post-processing of the output (e.g., response) from the generative output engine. That is, the generative service may be decided from a quantity of candidate labels, which label best or most closely fits with the content targeted by the label action component 920. In some examples, the generative service may be constrained to provide a single label as a response. In some cases, the generative service may be so constrained by a label prompt provided to the generative service by the collaboration platform or collaboration system responsive to the running of the automation rule. In other examples, the generative service may be allowed (e.g., by the generated label prompt) to return an empty set, or no labels. In such case a message indicating such response (or an error message) may displayed for a user (e.g., as a pop up window in the graphical user interface of a collaboration platform), or a message transmitted to a user by the collaboration platform, or a log entry created for automation rules in the collaboration platform.

In some examples, the selection criteria includes all relevant (e.g., applicable, fitting, similar) labels, for example as determined by the generative service. That is, the generative service may be decided from a quantity of candidate labels, which labels are relevant to the content targeted by the label action component 920. In some examples, the generative service may be tuned to determine relevance according to some relevance threshold. For example, a matching or relevance metric or threshold may be specified by the user (or specified within the collaboration platform) and indicated to the generative service in the prompt generated responsive to the running of the automation rule. In other example, the generative service may be left to determine relevance (e.g., in the absence of an indication of a relevance threshold to be used in the generated prompt). In some examples, the generative service may be constrained to provide no more than a threshold quantity of relevant label (e.g., no more than three, four, etc.), for example via an indication of a maximum quantity of labels provided in the generated prompt. In some examples, a user may have the option to indicate the maximum quantity via an input field in the component specification window 902. In other examples, the maximum may be set in the collaboration platform or system.

The rule builder 302 also includes a label action window 930, which may be an example of the label action window 330. The label action window 930 includes a first input 932, a second input 934, and a third input 936. In some examples, the second input 934 may be optional. In some examples, the first input 932, the second input 934, and the third input 936 are examples of the first input 332, the second input 334, and the third input 336, respectively, as further described herein.

Although, the rule builder 302 is shown with a single instance of the label action window 930, in some examples, multiple label action windows may be used for a single label action component 920. In such case, two or more label action windows 930 may be used for a user to specify parameters for multiple different candidate labels, for example, by providing a set of inputs for one or more of the first input 932, the second input 934, and/or the third input 936 for each candidate label. However, the label action windows 930 need not be separately displayed windows, and may simply be separate input fields for different candidate labels within a same label action window 930.

In the case of multiple candidate labels, in some examples, a prompt may be generated for the generative service that includes all of the candidate labels and their associated parameters (e.g., as provided by a user via the first input 932, the second input 934, and/or the third input 936). In other examples, more than one prompt may be generated by the collaborative platform (e.g., one prompt per candidate label).

The relevance of a label may be determined according to one or more techniques. For example, each label may be selected in accordance with a label score. In some cases, a label having the highest label score may be selected first, followed by other labels based on their respective label score in a descending order. In some cases, the order of the labels is determined based on one heuristic of the multiple heuristics used to compute or determine the label score.

The label score may be determined in accordance with a set of multiple selection heuristics. The heuristics may be a combination of a heuristic based on labels associated with pages or documents that are similarly organized, a heuristic based on label popularity (e.g., a popularity index) within a document space or for a particular tenant, and/or heuristics based on other characteristics of the current page or document. Each heuristic may also be associated with an analysis of the content of the current page or document in order to classify the current page or document with respect to a set of keywords or subject matter of the content. The analysis may include a semantic analysis of the title of the content, a content summary, a content narrative, or other portions of the content associated with the page or document. In some cases, the analysis may also include an analysis of the page or document metadata.

Generally, a label may be selected by the automation rule based on content of the page, and/or content of the one or more other electronic documents or pages associated with a tree element of an array of hierarchically arranged tree elements (e.g., as shown in the navigational panel 1104 described with reference to FIG. 11). Further, the one or more other electronic documents or pages for recommending a label are selected based on their proximity in the page tree with the electronic documents or page for which the label is being recommended. Further, labels associated with an electronic document or page that is more proximate to the electronic document or page for which the label is being recommended may be given a higher label score over another electronic document or page which is farther away in the page tree. In other words, a label associated with a document or page that is more proximate to the electronic document or page may have a higher respective label score in comparison with another electronic document or page that is less proximate to the electronic document or page. Additionally, or alternatively, the one or more other electronic documents or pages may be selected based on their semantic similarity or semantic relatedness with the electronic document or page for which the label is being recommended.

While proximity of an electronic document or page in a page tree is one factor in calculating or determining a label score, popularity of a label may be another factor in calculation or determination of the label score. In some cases, the popularity of a label may be determined based on a number of users selecting a particular label, and/or a number of documents having the particular label and may be measured or computed as what is referred to as a popularity index. The popularity index may be a normalized metric of label usage that represents the frequency of use of a particular label as normalized by labeling activity in the system. The popularity index may be based on activity within a particular time frame or time window, which may omit old or outdated user labeling activity, which may be less relevant to current content or labeling schemes.

In some cases, a label may be selected by the automation rule based on session data or context data regarding a particular session in which an electronic document or page was edited or created. The session or context data may include, but is not limited to, one or more electronic documents or pages created, edited, viewed, and/or accessed by the user in the session, and their respective content and/or metadata, and/or one or more labels applied and/or recommended during the session. In some cases, the one or more electronic documents or pages created, edited, viewed, and/or accessed by the user in the session may be selected based on a number of navigational events and/or a sequence of creating, editing, viewing, and/or accessing of the one or more electronic documents or pages with respect to the electronic document or page. In other words, a label may be selected by the automation rule based on one or more electronic documents or pages which may be organized together in a page tree, and/or which may be typically viewed together in a given session or series of navigational events.

For example, if more users are visiting a particular page X after and/or before viewing the current page, a label based on content of the particular page X may have a higher respective label score in comparison to a label selected based on content of another page Y, which has a greater number of navigational events or page/document visits between a viewing of page Y and the current content or page. That is, page Y can be characterized as having a reduced navigational event metric as compared to page X. By way of further example, for the pages visited by the user in a session, a label selected from content of a page visited immediately before or after the current page may have a higher respective label score in comparison with a label selected based on content of another page that has been not visited immediately before or after the current page.

FIGS. 10A-D depict example input fields of a component specification window for a label action component that supports automation rule creation and automated content labeling for collaboration platforms.

Field 1001 depicts an example of a criteria specification input 910, providing example selectable inputs of ONLY THE BEST MATCH and/or ALL MATCHING LABELS.

Field 1002 depicts an example of a first input 932, providing example selectable inputs for labels of 1-ON-1 MEETING, ACCOUNTING, ADMIN, CODE-CONTRIBUTION, COLLABORATION, DECISION, ENGINEERING, ENGINEERING-PROMOTION, FINANCE, FY2024, MONICA, PROJECT DASHBOARD, TEAM-PYTHON, and/or TRAINING.

Field 1003 depicts an example of a second input 934, providing example selectable inputs of DOES CONTENT TITLE RELATE TO A GIVEN PROMPT?, DOES CONTENT BODY RELATE TO A GIVEN PROMPT?, and/or DOES CONTENT BODY AND TITLE RELATE TO A GIVEN PROMPT?.

Field 1004 depicts an example of a third input 936, providing example selectable inputs of WHEN AN ENGINEER IS WRITING A PROMOTION PACKET, AND SO ON. IT INCLUDES CONTENT RELATED TO PROMOTION, WHAT THEY WORK ON, AND WHY THEY SHOULD BE PROMOTED, for example that may be provided as an input with reference to the example label of ENGINEERING-PROMOTION.

FIG. 11 depicts an example view of a graphical user interface in accordance with the embodiments described herein. Graphical user interface 1100 depicts a graphical user interface in a viewer or document/page view mode. For example, a graphical user interface 1100 is a rendering of an electronic document, page, or electronic content 1102 on a client device, such as the client device 104 or 106. The electronic document, page, or electronic content 1102 may be rendered on the client device upon authorization/authentication of a user by an authentication/authorization service, and based on permissions granted to the user according to a user profile associated with the user. In one example, the graphical user interface 1100 may have various partitions/sections displaying different content. For example, the graphical user interface 1100 may include a navigational panel 1104, a page toolbar 1106, and a content panel 1108.

The navigational panel 1104 may include a hierarchical element tree 1105, which may also be referred to herein as a page tree. The hierarchical element tree 1105 may include an array of hierarchically arranged tree elements. Each tree element of the array of hierarchically arranged tree elements may be positioned and/or displayed with respect to its respective relationship with a current electronic document, page, or electronic content being displayed in the content panel 1108. Further each tree element of the array of hierarchically arranged tree elements may be selectable. In other words, in response to a user action or user input with respect to a tree element, an electronic document, page, or electronic content associated with the tree element may be displayed in the content panel 1108 or a new instance of a graphical user interface.

While the content (for example, the user-generated content) for reading or viewing by the user is displayed in the content panel 1108, the content panel 1108 may also display a label generation user interface within the user-generated content of the content panel 1108. The label generation user interface may include a text entry field 1110 (also referred to as a text entry region), and an array of label graphical elements. The label graphical elements may have been previously assigned to the current page or document and are each selectable in order to cause display of a label search result interface (similar to the example depicted in FIG. 12 described below).

As further described herein, labels may be generated and attached to content in response to automation rules. An indication, such as label graphical elements, of generated labels may be provided on or with associated content. For example, one or more of the DESIGN, FY 22, UX, and/or TEAM PYTHON labels may have been generated for the current page or document according to an automation rule. In some examples, a user may opt to delete one or more of these generated labels. Additionally, a user may use the text entry field 1110 to search for and display suggested labels for the page or document, such as the suggested labels 1116.

Note that the label generation user interface and text entry field 1110 may be displayed for anyone with view permissions with respect to the current page or document in the page or document view mode. However, in some cases, only users having editing permissions with respect to the current page or document may add or delete labels associated with the current page or document. Furthermore, if the graphical user interface is transitioned from a document or page view mode to a document or page edit mode (by, for example, selection of the pencil control in the selectable controls of page toolbar 1106), display of the label generation user interface and the array of selectable label graphical elements may be suppressed. Once the graphical user interface is transitioned back into a page or document view mode (by, for example, selecting a “publish” or view” control in the selectable controls), any revised user-generated content may be displayed and the label generation user interface may be displayed (or unsuppressed). In some cases, the display of the navigational panel 1104 may also be suppressed when the graphical user interface is in a page or document edit mode.

As shown in the graphical user interface 1100, each selectable label graphical object displayed in the text input field 1110 may have a respective delete control to delete or remove the particular label. For example, the respective delete control may be a region designated by the “x” depicted within each selectable label graphical object. User input provided to the delete control may cause the label to be deleted or removed from the text entry field. Additionally, or alternatively, the user may right click on the label, and the user may be presented an option to delete or remove the label from the text entry field. In some cases, when the label is deleted or removed from the text entry field, a check may be performed to determine whether the removed label is assigned as a label to any electronic document or page being managed by the document management platform. Upon determining that the removed label is not assigned to any electronic document or page, the removed label may be removed from the local storage or memory from a registry of available labels.

In some examples, a user selection of a label displayed in the graphical user interface 1100 causes one or more actions to be performed within the collaboration platform using the selected label as an input. In response to the label selection, the collaboration platform may cause a search for content related to the selected label to be performed. For example, upon a user selection of a label, the collaboration platform may identify a set of content tagged with the same label and display indications (e.g., graphical elements) corresponding to the identified content. In some examples, the set of content identified by the collaboration platform may include only the top-ranked content related to the selected label. In some cases, content related to the label is content that also has that same label. In other cases, different labels may be grouped or otherwise associated, such that the selection of one label may result in content tagged with another label being also identified.

In response to the selection of a label, the collaboration platform may also filter displayed results in the collaboration platform. For example, in a documentation platform, graphical elements representing documents may be displayed, along with one or more graphical elements representing a label. The selection of a graphical element representing a label may filter out documents such that other documents that are also tagged with that same label is displayed. In another example, in an issue tracking platform, graphical elements representing issues may be displayed, along with one or more graphical elements representing a label. The selection of a graphical element representing a label may filter out other issues tagged with other labels such that content that is also tagged with that same issue is displayed.

FIG. 12 depicts an example view of a graphical user interface 1200 displaying a list of a plurality of electronic documents or pages having the same label in accordance with the examples described herein. Specifically, the content panel 1208 includes a list of objects associated with a document space or set of documents spaced provided by the tenant that are associated with a particular label. Each label displayed in a graphical user interface may be a selectable graphical element, which means a user can click, double click, tap, or double tap on the label graphical element to view one or more electronic documents or pages having the same particular label, as shown in an example view of a graphical user interface 1200. As shown in the graphical user interface 1200, one or more electronic documents or pages having the particular label may be displayed in the content panel 1208. Alternatively, the one or more electronic documents pages having the particular label may be displayed in a pop-up window. Further, the one or more electronic documents or pages may be displayed in an order based on their semantic similarity or semantic relatedness with the electronic document or page which the user is currently creating, editing, accessing, or viewing.

In some cases, one or more other related labels 1206 that are generally used or applied to electronic documents or pages with the particular label may also be listed. Accordingly, the user may apply one or more related labels to the electronic document or page, which may further improve searchability of the electronic document or page. Further, functions and aspects of the graphical user interface 1200 may be displayed and available to the user in editor and/or viewer mode of the graphical user interface.

FIG. 13 depicts an example view of a graphical user interface 1300 displaying labels in connection with issues of an issue tracking system. In some examples, the creation or modification of an issue in an issue tracking system may trigger the execution of an automation rule, as further described herein. A user may create or modify an issue, for which a representative graphical element 1310 is displayed in the graphical user interface 1300. One or more automation rules may be triggered as a result, and a label selected as a result of the one or more automation rules being run. A graphical indicator 1312 of the label may then be shown in the graphical user interface 1300. In some examples, where no label is attached to or otherwise associated with an issue, a graphical indicator 1314 may be displayed in the graphical user interface 1300.

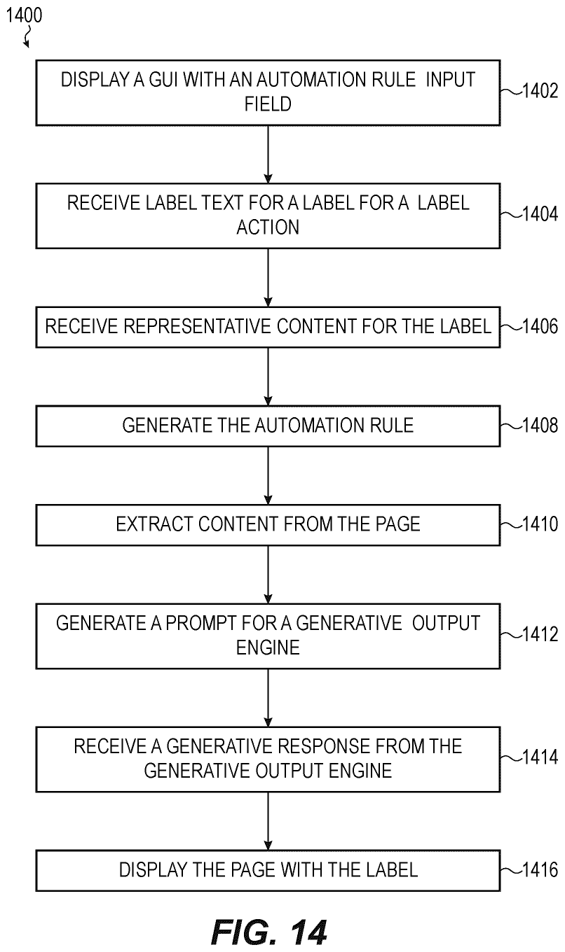

FIG. 14 depicts an example method 1400 for collaboration content generation within a collaboration platform, according to one or more aspects described herein. In one or more embodiments, method 1400 supports one or more aspects of automation rule creation and automated content labeling for collaboration platforms, as further described herein, for example with reference to any one or more of FIGS. 1-13. In some cases, the method 1400 may be performed by a processor. In some embodiments, the processor may include one or more processor cores, and memory that is coupled to the processor core(s). The memory may store instructions that, when executed by the processor core(s), causes the processor to perform the operations of the method 1400. As the processor performs the operations of the method 1400, the processor may also cause other components of the collaboration system to perform, or discontinue, various operations.

At 1402, the method 1400 includes displaying a GUI with an automation rule input field. In some embodiments, the method 1400 includes causing display of a graphical user interface of a collaboration platform, the graphical user interface including an input field for receiving user input to create an automation rule.

At 1404, the method 1400 includes receiving label text for a label for a label action. In some embodiments, the method 1400 includes receiving a first input of the graphical user interface designating, for a label action of the automation rule, a label text for a label.

At 1406, the method 1400 includes receiving representative content for the label. In some embodiments, the method 1400 includes receiving a second input of the graphical user interface designating, for the label action, a representative content for the label.

At 1408, the method 1400 includes generating the automation rule. In some embodiments, the method 1400 includes causing generation, using the label text and the representative content, of the automation rule that includes the label action.

At 1410, the method 1400 includes extracting content from the page. In some embodiments, the method 1400 includes subsequent to generating the automation rule and in response to a trigger criteria being satisfied with respect to a page hosted by the collaboration platform, extracting content from the page.

At 1412, the method 1400 includes generating a prompt for a generative output engine. In some embodiments, the method 1400 includes generating a first prompt for a generative output engine, the first prompt comprising the extracted content and the representative content.

At 1414, the method 1400 includes receiving a generative response from the generative output engine. In some embodiments, the method 1400 includes, in response to a generative response from the generative output engine indicating the label, associating the label with the page.

At 1416, the method 1400 includes displaying the page with the label. In some embodiments, the method 1400 includes causing display of the page including a graphical indicator of the label text for the label on the page.

In one or more embodiments, the method further includes selecting, based at least in part on the label text for the label, a set of pages hosted by the collaboration platform. The method may further include extracting content from the set of pages. The method may further include generating a second prompt for the generative output engine, the second prompt including the content extracted from the set of pages, and providing the second prompt to the generative output engine. The method may further include receiving, from the generative output engine, a generative response and generating the representative content using the generative response.

In one or more embodiments, the method further includes receiving a third input of the graphical user interface designating, for the label action, a selection criterion for the label. The method may further include receiving a fourth input of the graphical user interface designating, for the label action of the automation rule, additional label text for one or more additional labels. The method may further include, in response to the trigger criteria being satisfied with respect to the page, generating a second prompt for the generative output engine, the second prompt including the extracted content and representative content for the one or more additional labels, where the generative response indicates a selection, based at least in part on the selection criterion, of at least one label from among the label or the one or more additional labels.

In one or more embodiments, the method further includes receiving a third input of the graphical user interface selecting a second action for the automation rule, the second action, when executed, including determining, based on the label indicated by the generative output engine, one or more users associated with the label, and providing, to the one or more users, an indication of the page hosted by the collaboration platform.

In one or more embodiments, the method further includes receiving a third input of the graphical user interface selecting a second action for the automation rule, the second action, when executed, including determining, based on the label indicated by the generative output engine, an administrator for a space that includes the page, and providing, to the administrator, a notification that the label has been associated with the page hosted by the collaboration platform.

In some embodiments, the graphical indicator of the label text for the label is displayed in a content portion of the page. In one or more embodiments, the method further includes receiving a third input of the graphical user interface selecting the graphical indicator of the label text; and in response to the selection of the graphical indicator of the label text, causing display of graphical indicators of one or more pages associated with the label.

In one or more embodiments, the method further includes, subsequent to generating the automation rule and in response to the trigger criteria being satisfied with respect to the page, checking whether a user associated with the automation rule has write permission for the page, the label associated with the page based at least in part on the user having the write permission for the page.

In one or more embodiments, the method further includes receiving a third input of the graphical user interface designating one or more portions of the page as a source of the extracted content, where the one or more portions of the page include a body of the page, a title of the page, or a combination of the body and the title.

The method 1400 may be variously embodied, extended, or adapted, as described in the following paragraphs and elsewhere in this description.

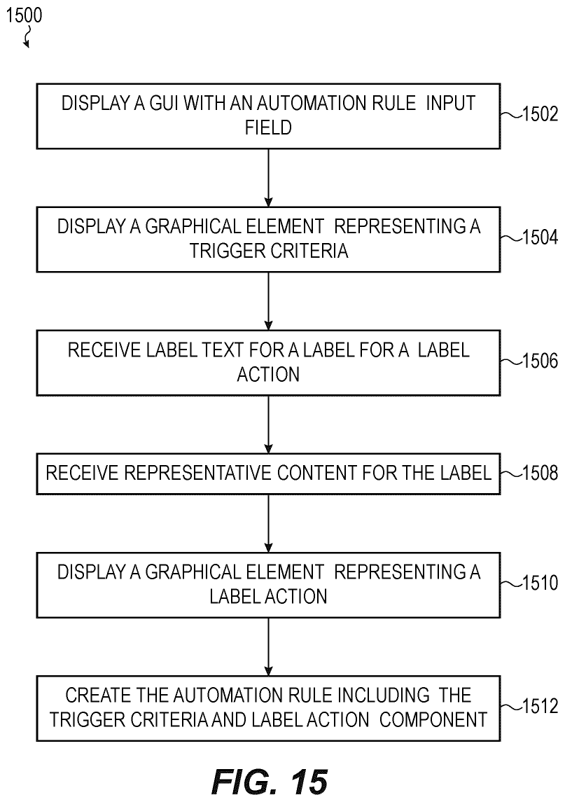

FIG. 15 depicts an example method 1500 for collaboration content generation within a collaboration platform, according to one or more aspects described herein. In one or more embodiments, method 1500 supports one or more aspects of automation rule creation and automated content labeling for collaboration platforms, as further described herein, for example with reference to any one or more of FIGS. 1-13. In some cases, the method 1500 may be performed by a processor. In some embodiments, the processor may include one or more processor cores, and memory that is coupled to the processor core(s). The memory may store instructions that, when executed by the processor core(s), causes the processor to perform the operations of the method 1500. As the processor performs the operations of the method 1500, the processor may also cause other components of the collaboration system to perform, or discontinue, various operations.

At 1502, the method 1500 includes displaying a GUI with an automation rule input field. In some embodiments, the method 1500 includes causing display of a rule builder graphical user interface of a collaboration platform, the rule builder graphical user interface including a user input field.

At 1504, the method 1500 includes displaying a graphical element representing a trigger criteria. In some embodiments, the method 1500 includes in response to receiving a first input of the rule builder graphical user interface designating a trigger criteria with respect to an object hosted by the collaboration platform, causing generation of a first graphical element representing the trigger criteria in a proposed automation rule flow in the rule builder graphical user interface.

At 1506, the method 1500 includes receiving label text for a label for a label action. In some embodiments, the method 1500 includes receiving a second input of the rule builder graphical user interface for a label action triggered by the trigger criteria, the second input designating, for the label action, a label text of a label.

At 1508, the method 1500 includes receiving representative content for the label. In some embodiments, the method 1500 includes receiving a third input of the rule builder graphical user interface for the label action, the third input designating a representative content of the label.

At 1510, the method 1500 includes displaying a graphical element representing a label action. In some embodiments, the method 1500 includes in response to receiving the second input and the third input, causing generation of a second one or more graphical elements representing the label action in the proposed automation rule flow.

At 1512, the method 1500 includes creating the automation rule including the trigger criteria and label action component. In some embodiments, the method 1500 includes in response to receiving a fourth input of the rule builder graphical user interface indicating for the collaboration platform to save an automation rule that includes a trigger component for the trigger criteria and a label action component for the label action, generating a service on the collaboration platform configured to provide, in response to the trigger criteria being satisfied, a label application prompt to a generative output engine, the label application prompt including content extracted from the object and the representative content and, in response to a generative response from the generative output engine, associate the label with the object.

In some embodiments, the label includes a first label, the label text includes a first label text, and the representative content includes a first representative content. Additionally, the method may further include receiving a fifth input of the rule builder graphical user interface designating, for the label action of the automation rule, additional label text for one or more additional labels, and receiving a sixth input of the rule builder graphical user interface designating, for the label action, representative content for the one or more additional labels. In some embodiments, the label application prompt includes the content extracted from the object, the representative content for the label, and the representative content for the one or more additional labels.

In some embodiments, the object of the collaboration platform includes a page of a document management platform, an issue of an issue tracking platform, a project of a project management platform, a document of a source-code repository platform. In some embodiments, the trigger criteria includes a page publication, a page modification, or a page insertion in a page space or page tree.

In some embodiments, the second input includes a user selection of the label from a pre-populated list of labels, and the second input includes a text string entered into the rule builder graphical user interface by a user, and the label text displayed with the object includes the entered text string. In some embodiments, the third input includes a text string entered into the rule builder graphical user interface by a user, and the representative content includes the entered text string.

In some embodiments, the label assignment prompt further includes representative content for one or more additional labels, and the generative response from the generative output engine indicates a best match between the extracted content and one label from among the label or the one or more additional labels. In some embodiments, the label assignment prompt further includes representative content for one or more additional labels, and the generative response from the generative output engine indicates any match between the extracted content and labels of the extracted content and the one or more additional labels.

In some embodiments, the collaboration platform includes one or more of a document management platform, an issue tracking platform, a project management platform, or a source-code repository platform, and the generative output engine is external to the collaboration platform. In some embodiments, the collaboration platform further includes the generative output engine.

The method 1500 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 1400 or 1500. Embodiments contemplated herein include an apparatus having logic, modules, or circuitry to perform one or more elements of the method 1400 or 1500. Embodiments contemplated herein include an apparatus having one or more processors and one or more computer-readable media, using or storing instructions that, when executed by the one or more processors, cause the one or more processors to perform one or more elements of the method 1400 or 1500. Embodiments contemplated herein include a signal as described in or related to one or more elements of the method 1400, or 1500. Embodiments contemplated herein include a computer program or computer program product having instructions, wherein execution of the program by a processor causes the processor to carry out one or more elements of the method 1400 or 1500.

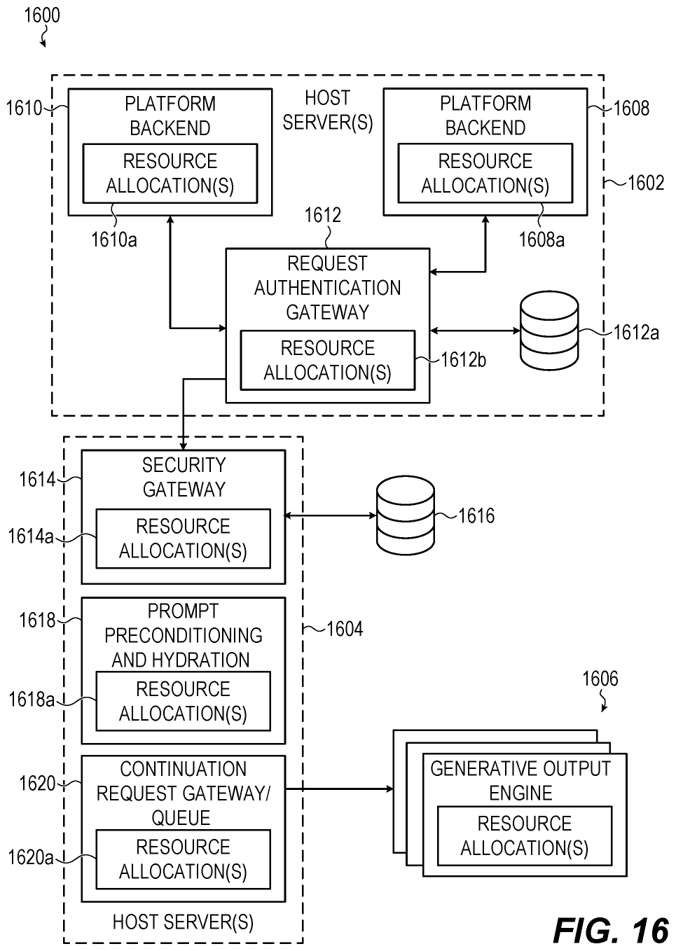

FIG. 16 depicts a system diagram and network/communication architectures that may support a system as described herein. The system 1600 includes a first set of host servers 1602 associated with one or more software platform backends. These software platform backends can be communicably coupled to a second set of host servers 1604 purpose configured to process requests and responses to and from one or more generative output engines 1606.

Specifically, the first set of host servers 1602 (which, as described above can include processors, memory, storage, network communications, and any other suitable physical hardware cooperating to instantiate software) can allocate certain resources to instantiate a first and second platform backend, such as a first platform backend 1608 and a second platform backend 1610. Each of these respective backends can be instantiated by cooperation of processing and memory resources associated to each respective backend. As illustrated, such dedicated resources are identified as the resource allocations 1608a and the resource allocations 1610a.

Each of these platform backends can be communicably coupled to an authentication gateway 1612 configured to verify, by querying a permissions table, directory service, or other authentication system (represented by the database 1612a) whether a particular request for generative output from a particular user is authorized. Specifically, the second platform backend 1610 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 1612 can deny the request for insufficient permissions. This example is merely one and is not intended to be limiting; many possible authorization and authentication operations can be performed by the authentication gateway 1612. The authentication gateway 1612 may be supported by physical hardware resources, such as a processor and memory, represented by the resource allocations 1612b.

Once the authentication gateway 1612 determines that a request from a user of either platform is authorized to access data or resources implicated in service that request, the request may be passed to a security gateway 1614, which may be a software instance supported by physical hardware identified in FIG. 16 as the resource allocations 1614a. The security gateway 1614 may be configured to determine whether the request itself conforms to one or more policies or rules (data and/or executable representations of which may be stored in a database 1616) established by the organization. For example, the organization may prohibit executing prompts for offensive content, value-incompatible content, personally identifying information, health information, trade secret information, unreleased product information, secret project information, and the like. In other cases, a request may be denied by the security gateway 1614 if the prompt requests are beyond a threshold quantity of data.

Once a particular user-initiated prompt has been sufficiently authorized and cleared against organization-specific generative output rules, the request/prompt can be passed to a preconditioning and hydration service 1618 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 1618 can be a software instance supported by physical hardware represented by the resource allocations 1618a. In some implementations, the hydration service 1618 may also be used to rehydrate personally identifiable information (PII) or other potentially sensitive data that has been extracted from a request or data exchange in the system.

One a prompt has been modified, replaced, or hydrated by the preconditioning and hydration service 1618, it may be passed to an output gateway 1620 (also referred to as a continuation gateway or an output queue). The output gateway 1620 may be responsible for enqueuing and/or ordering different requests from different users or different software platforms based on priority, time order, or other metrics. The output gateway 1620 can also serve to meter requests to the generative output engines 1606.

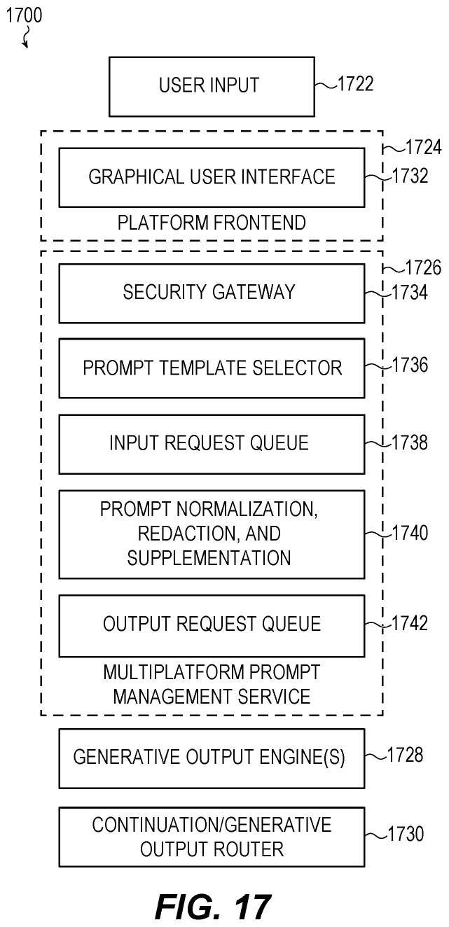

FIG. 17 depicts a functional system diagram of the system 1600. In particular, the system 1700 is configured to operate as a multiplatform prompt management service supporting and ordering requests from multiple users across multiple platforms. In particular, a user input 1722 may be received at a platform frontend 1724. The platform frontend 1724 passes the input to a prompt management service 1726 that formalizes a prompt suitable for input to a generative output engine 1728, which in turn can provide its output to an output router 1760 that may direct generative output to a suitable destination. For example, the output router 1760 may execute API requests generated by the generative output engine 1728, may submit text responses back to the platform frontend 1724, may wrap a text output of the generative output engine 1728 in an API request to update a backend of the platform associated with the platform frontend 1724, or may perform other operations.

Specifically, the user input 1722 (which may be an engagement with a button, typed text input, spoken input, chat box input, and the like) can be provided to a GUI 1732 of the platform frontend 1724. The GUI 1732 can be communicably coupled to a security gateway 1734 of the prompt management service 1726 that may be configured to determine whether the user input 1722 is authorized to execute and/or complies with organization-specific rules.

The security gateway 1734 may provide output to a prompt selector 1736 which can be configured to select a prompt template from a database of preconfigured prompts, templatized prompts, or engineered templatized prompts. Once the raw user input is transformed into a string prompt, the prompt may be provided as input to a request queue 1738 that orders different user request for input from the generative output engine 1728. Output of the request queue 1738 can be provided as input to a prompt hydrator 1740 configured to populate template fields, add context identifiers, supplement the prompt, and perform other normalization operations described herein. In other cases, the prompt hydrator 1740 can be configured to segment a single prompt into multiple discrete requests, which may be interdependent or may be independent.

Thereafter, the modified prompt(s) can be provided as input to an output queue at 1742 that may serve to meter inputs provided to the generative output engine 1728.

These foregoing embodiments are depicted in FIGS. 16-17 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

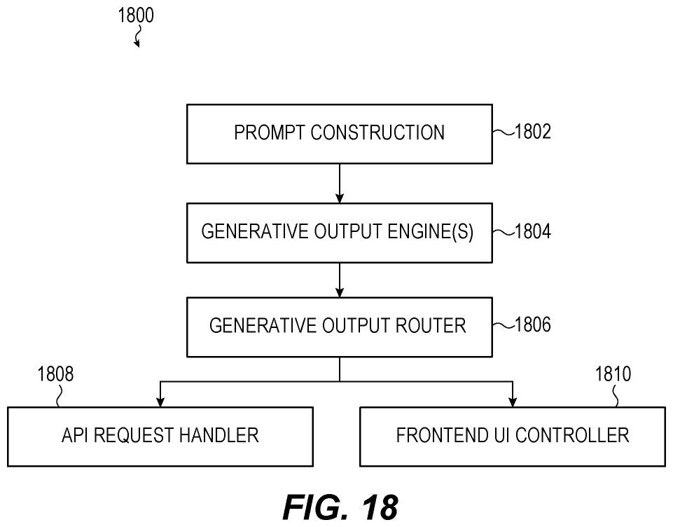

Although many constructions are possible, FIG. 18 depicts a simplified system diagram and data processing pipeline as described herein. The system 1800 receives user input, and constructs a prompt therefrom at operation 1802. After constructing a suitable prompt, and populating template fields, selecting appropriate instructions and examples for an LLM to continue, the modified constructed prompt is provided as input to a generative output engine 1804. A continuation from the generative output engine 1804 is provided as input to a router 1806 configured to classify the output of the generative output engine 1804 as being directed to one or more destinations. For example, the router 1806 may determine that a particular generative output is an API request that should be executed against a particular API (e.g., such as an API of a system or platform as described herein). In this example, the router 1806 may direct the output to an API request handler 1808. In another example, the router 1806 may determine that the generative output may be suitably directed to a GUI/frontend. For example, a generative output may include suggestions to be shown to a user below a user's partial input, such as shown in FIGS. 3-10.

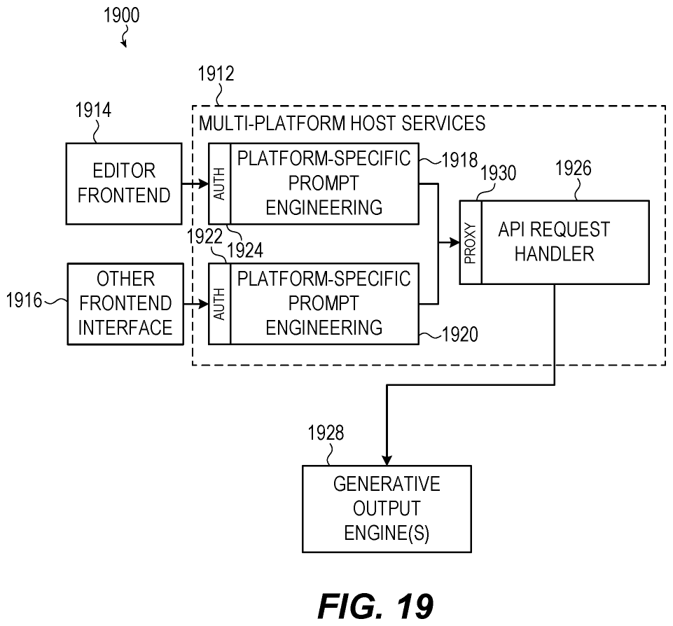

Another example architecture is shown in FIG. 19, illustrating a system providing prompt management, and in particular multiplatform prompt management as a service. The system 1900 is instantiated over cloud resources, which may be provisioned from a pool of resources in one or more locations (e.g., datacenters). In the illustrated embodiment, the provisioned resources are identified as the multi-platform host services 1912.

The multi-platform host services 1912 can receive input from one or more users in a variety of ways. For example, some users may provide input via an editor region 1914 of a frontend, such as described above. Other users may provide input by engaging with other user interface elements 1916 unrelated to common or shared features across multiple platforms. Specifically, the second user may provide input to the multi-platform host services 1912 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 1912 can include multiple software instances or microservices each configured to receive user inputs and/or proposed prompts and configured to provide, as output, an engineered prompt. In many cases, these instances—shown in the figure as the platform-specific prompt engineering services 1918, 1920—can be configured to wrap proposed prompts within engineered prompts retrieved from a database such as described above.

In many cases, the platform-specific prompt engineering services 1918, 1920 can be each configured to authenticate requests received from various sources. In other cases, requests from editor regions or other user interface elements of particular frontends can be first received by one or more authenticator instances, such as the authentication instances 1922, 1924. In other cases, a single centralized authentication service can provide authentication as a service to each request before it is forwarded to the platform-specific prompt engineering services 1918, 1920.

Once a prompt has been engineered/supplemented by one of the platform-specific prompt engineering services 1918, 1920, it may be passed to a request queue/API request handler 1926 configured to generate an API request directed to a generative output engine 1928 including appropriate API tokens and the engineered prompt as a portion of the body of the API request. In some cases, a service proxy 1930 can interpose the platform-specific prompt engineering services 1918, 1920 and the request queue/API request handler 1926, so as to further modify or validate prompts prior to wrapping those prompts in an API call to the generative output engine 1928 by the request queue/API request handler 1926 although this is not required of all embodiments.

These foregoing embodiments are depicted in FIGS. 16-19 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

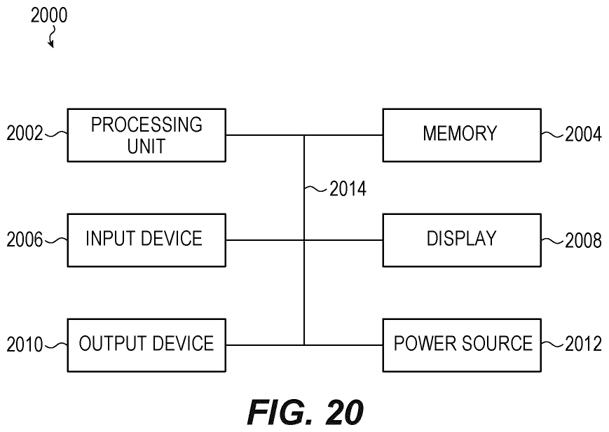

FIG. 20 shows a sample electrical block diagram of an electronic device 2000 that may perform the operations described herein. The electronic device 2000 may in some cases take the form of any of the electronic devices described with reference to FIGS. 1-19, including client devices, and/or servers or other computing devices associated with the system 100. The electronic device 2000 can include one or more of a processing unit 2002, a memory 2004 or storage device, input devices 2006, a display 2008, output devices 2010, and a power source 2012. In some cases, various implementations of the electronic device 2000 may lack some or all of these components and/or include additional or alternative components.

The processing unit 2002 can control some or all of the operations of the electronic device 2000. The processing unit 2002 can communicate, either directly or indirectly, with some or all of the components of the electronic device 2000. For example, a system bus or other communication mechanism 2014 can provide communication between the processing unit 2002, the power source 2012, the memory 2004, the input device(s) 2006, and the output device(s) 2010.

The processing unit 2002 can be implemented as any electronic device capable of processing, receiving, or transmitting data or instructions. For example, the processing unit 2002 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 2000 can be controlled by multiple processing units. For example, select components of the electronic device 2000 (e.g., an input device 2006) may be controlled by a first processing unit and other components of the electronic device 2000 (e.g., the display 2008) may be controlled by a second processing unit, where the first and second processing units may or may not be in communication with each other.

The power source 2012 can be implemented with any device capable of providing energy to the electronic device 2000. For example, the power source 2012 may be one or more batteries or rechargeable batteries. Additionally, or alternatively, the power source 2012 can be a power connector or power cord that connects the electronic device 2000 to another power source, such as a wall outlet.

The memory 2004 can store electronic data that can be used by the electronic device 2000. For example, the memory 2004 can store electronic data or content such as, for example, audio and video files, documents and applications, device settings and user preferences, timing signals, control signals, and data structures or databases. The memory 2004 can be configured as any type of memory. By way of example only, the memory 2004 can be implemented as random access memory, read-only memory, flash memory, removable memory, other types of storage elements, or combinations of such devices.

In various embodiments, the display 2008 provides a graphical output, for example associated with an operating system, user interface, and/or applications of the electronic device 2000 (e.g., a chat user interface, an issue-tracking user interface, an issue-discovery user interface, etc.). In one embodiment, the display 2008 includes one or more sensors and is configured as a touch-sensitive (e.g., single-touch, multi-touch) and/or force-sensitive display to receive inputs from a user. For example, the display 2008 may be integrated with a touch sensor (e.g., a capacitive touch sensor) and/or a force sensor to provide a touch- and/or force-sensitive display. The display 2008 is operably coupled to the processing unit 2002 of the electronic device 2000.

The display 2008 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 2008 is positioned beneath and viewable through a cover that forms at least a portion of an enclosure of the electronic device 2000.

In various embodiments, the input devices 2006 may include any suitable components for detecting inputs. Examples of input devices 2006 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 2006 may be configured to detect one or more particular types of input and provide a signal (e.g., an input signal) corresponding to the detected input. The signal may be provided, for example, to the processing unit 2002.

As discussed above, in some cases, the input device(s) 2006 include a touch sensor (e.g., a capacitive touch sensor) integrated with the display 2008 to provide a touch-sensitive display. Similarly, in some cases, the input device(s) 2006 include a force sensor (e.g., a capacitive force sensor) integrated with the display 2008 to provide a force-sensitive display.

The output devices 2010 may include any suitable components for providing outputs. Examples of output devices 2010 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 2010 may be configured to receive one or more signals (e.g., an output signal provided by the processing unit 2002) and provide an output corresponding to the signal.

In some cases, input devices 2006 and output devices 2010 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 2002 may be operably coupled to the input devices 2006 and the output devices 2010. The processing unit 2002 may be adapted to exchange signals with the input devices 2006 and the output devices 2010. For example, the processing unit 2002 may receive an input signal from an input device 2006 that corresponds to an input detected by the input device 2006. The processing unit 2002 may interpret the received input signal to determine whether to provide and/or change one or more outputs in response to the input signal. The processing unit 2002 may then send an output signal to one or more of the output devices 2010, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for collaboration content generation within a collaboration platform, the method comprising:
causing display of a graphical user interface of the collaboration platform, the graphical user interface including an input field for receiving user input to create an automation rule;
receiving a first input of the graphical user interface designating, for a label action of the automation rule, a label text for a label;
receiving a second input of the graphical user interface designating, for the label action, a representative content for the label;
causing generation, using the label text and the representative content, of the automation rule that includes the label action;
subsequent to generating the automation rule and in response to a trigger criteria being satisfied with respect to a page hosted by the collaboration platform:
extracting content from the page; and
generating a first prompt for a generative output engine, the first prompt comprising the extracted content and the representative content;
in response to a generative response from the generative output engine indicating the label, associating the label with the page; and
causing display of the page including a graphical indicator of the label text for the label on the page.
The method of claim 1, wherein designating the representative content for the label comprises:
selecting, based at least in part on the label text for the label, a set of pages hosted by the collaboration platform;
extracting content from the set of pages;
generating a second prompt for the generative output engine, the second prompt comprising the content extracted from the set of pages;
providing the second prompt to the generative output engine;
receiving, from the generative output engine, the generative response; and
generating the representative content using the generative response.
The method of claim 1, further comprising:
receiving a third input of the graphical user interface designating, for the label action, a selection criterion for the label;
receiving a fourth input of the graphical user interface designating, for the label action of the automation rule, additional label text for one or more additional labels; and
in response to the trigger criteria being satisfied with respect to the page:
generating a second prompt for the generative output engine, the second prompt comprising the extracted content and representative content for the one or more additional labels, wherein:
the generative response indicates a selection, based at least in part on the selection criterion, of at least one label from among the label or the one or more additional labels.
The method of claim 1, further comprising:
receiving a third input of the graphical user interface selecting a second action for the automation rule, the second action, when executed, comprising:
determining, based on the label indicated by the generative output engine, one or more users associated with the label; and
providing, to the one or more users, an indication of the page hosted by the collaboration platform.
The method of claim 1, further comprising:
receiving a third input of the graphical user interface selecting a second action for the automation rule, the second action, when executed, comprising:
determining, based on the label indicated by the generative output engine, an administrator for a space that includes the page; and
providing, to the administrator, a notification that the label has been associated with the page hosted by the collaboration platform.
The method of claim 1, wherein:
the graphical indicator of the label text for the label is displayed in a content portion of the page.
The method of claim 6, further comprising:
receiving a third input of the graphical user interface selecting the graphical indicator of the label text; and
in response to the selection of the graphical indicator of the label text, causing display of graphical indicators of one or more pages associated with the label.
The method of claim 1, further comprising:
subsequent to generating the automation rule and in response to the trigger criteria being satisfied with respect to the page, checking whether a user associated with the automation rule has write permission for the page, the label associated with the page based at least in part on the user having the write permission for the page.
The method of claim 1, further comprising:
receiving a third input of the graphical user interface designating one or more portions of the page as a source of the extracted content, wherein the one or more portions of the page comprise a body of the page, a title of the page, or a combination of the body and the title.

2. A computer-implemented method for collaboration content generation within a collaboration platform, the method comprising:
causing display of a rule builder graphical user interface of the collaboration platform, the rule builder graphical user interface including a user input field;
in response to receiving a first input of the rule builder graphical user interface designating a trigger criteria with respect to an object hosted by the collaboration platform:
causing generation of a first graphical element representing the trigger criteria in a proposed automation rule flow in the rule builder graphical user interface;
receiving a second input of the rule builder graphical user interface for a label action triggered by the trigger criteria, the second input designating, for the label action, a label text of a label; and
receiving a third input of the rule builder graphical user interface for the label action, the third input designating a representative content of the label;
in response to receiving the second input and the third input:
causing generation of a second one or more graphical elements representing the label action in the proposed automation rule flow; and
in response to receiving a fourth input of the rule builder graphical user interface indicating for the collaboration platform to save an automation rule that includes a trigger component for the trigger criteria and a label action component for the label action:
generating a service on the collaboration platform configured to:
provide, in response to the trigger criteria being satisfied, a label application prompt to a generative output engine, the label application prompt including content extracted from the object and the representative content; and
in response to a generative response from the generative output engine, associate the label with the object.
The method of claim 10, wherein:
the label comprises a first label;
the label text comprises a first label text;
the representative content comprises a first representative content; and
the method further comprises:
receiving a fifth input of the rule builder graphical user interface designating, for the label action of the automation rule, additional label text for one or more additional labels; and
receiving a sixth input of the rule builder graphical user interface designating, for the label action of the automation rule, representative content for the one or more additional labels, wherein:
the label application prompt includes the content extracted from the object, the representative content for the label, and the representative content for the one or more additional labels.
The method of claim 10, wherein:
the object of the collaboration platform comprises a page of a document management platform, an issue of an issue tracking platform, a project of a project management platform, or a document of a source-code repository platform.
The method of claim 10, wherein the second input comprises:
a user selection of the label from a pre-populated list of labels; or
a text string entered into the rule builder graphical user interface by a user; and
the label text displayed with the object comprises the entered text string.
The method of claim 10, wherein:
the third input comprises a text string entered into the rule builder graphical user interface by a user; and
the representative content comprises the entered text string.
The method of claim 10, wherein:
the trigger criteria comprises a page publication, a page modification, or a page insertion in a page space or page tree.

3. A collaboration platform, comprising:
a first interface configured to communicate with at least one client device;
a second interface configured to communicate with a generative output engine; and
a centralized automation rule service coupled with the first interface and the second interface, the centralized automation rule service configured to:
in response to detecting that an object associated with a page hosted by the collaboration platform has been created or modified by a user:
extracting content from the page according to an automation rule; and
generating a label assignment prompt for the generative output engine, the label assignment prompt comprising the extracted content and representative content specified by the automation rule;
providing the label assignment prompt to the generative output engine using an application program interface call; and
obtaining a generative response from the generative output engine responsive to the application program interface call; and
in response to a generative response from the generative output engine indicating a label:
associating the label with the page; and
causing display of the page, including a graphical indicator including label text of the label.
The collaboration platform of claim 16, wherein:
the label assignment prompt further comprises representative content for one or more additional labels; and
the generative response from the generative output engine indicates a best match between the extracted content and one label from among the label or the one or more additional labels.
The collaboration platform of claim 16, wherein:
the label assignment prompt further comprises representative content for one or more additional labels; and
the generative response from the generative output engine indicates any match between the extracted content and labels of the extracted content and the one or more additional labels.
The collaboration platform of claim 16, wherein:
the collaboration platform comprises one or more of a document management platform, an issue tracking platform, a project management platform, or a source-code repository platform; and
the generative output engine is external to the collaboration platform.
The collaboration platform of claim 16, wherein:
the collaboration platform further comprises the generative output engine.
